(19) United States
(12) Patent Application Publication
(10) Pub. No.: US 2009/0283659 A1
(43) Pub. Date: Nov. 19, 2009

(54) YIELDABLE ASSEMBLY

(76) Inventor: Anthony J. Newbill, Wickenburg, AZ (US)

Correspondence Address: SCHMEISER OLSEN & WATTS, 18 E UNIVERSITY DRIVE, SUITE # 101, MESA, AZ, 85201, US

(21) Appl. No.: 12/507,712

(22) Filed: Jul. 22, 2009

Related U.S. Application Data
(63) Continuation-in-part of application No. 11/487,674, filed on Jul. 17, 2006.
Application No. 11/487,674 is a continuation-in-part of application No. 12/265,662, filed on Nov. 5, 2008.

(51) Int. Cl. F16M 13/00

(52) U.S. Cl. 248/624

(57) ABSTRACT

A post structure includes a base post having an upwardly facing opening, and a post component which includes a housing with a bottom wall having an opening facing the opening of the base post. The post structure includes a rigid fastener which extends through the base and bottom wall openings, and a first washer engaged with the fastener, and a spring positioned between the bottom wall and washer.

### CROSS-REFERENCE TO RELATED APPLICATIONS

This application claims priority to U.S. patent application Ser. No. 11/487,674, filed on Jul. 17, 2006, and U.S. patent application Ser. No. 12/265,662, filed on Nov. 5, 2008, the contents of both of which are incorporated by reference as though fully set forth herein.

### BACKGROUND OF THE INVENTION

1. Field of the Invention

The invention relates to a fixture assembly that is self-righting.

2. Description of the Related Art

There are many different types of self-righting fixture assemblies in use today, and they can be self-righting in many different ways. A self-righting fixture assembly yields in response to an applied force. Some self-righting fixture assemblies are designed to not break in response to the applied force, and are designed to right themselves in response to the applied force being removed. More information regarding self-righting fixture assemblies can be found in U.S. Pat. Nos. 1,249,315, 1,266,152, 1,269,212, 1,384,365, 1,402,465, 1,435,363, 1,435,379, 1,679,623, 3,099,150, 3,161,397, 3,658,284, 3,899,150, 4,172,579, 4,546,944, 4,792,088, 5,029,783, 5,215,283, 6,149,340, 7,032,811 and 7,121,004, the contents of all of which are incorporated by reference as though fully set forth herein.

Some of these self-righting fixture assemblies do not yield enough and end up breaking in response to the applied force. Further, some self-righting fixture assemblies do not self-right after being hit. Hence, they require being self-righted manually.

### BRIEF SUMMARY OF THE INVENTION

The present invention provides a self-righting fixture assembly. The novel features of the invention are set forth with particularity in the appended claims. The invention will be best understood from the following description when read in conjunction with the accompanying drawings.

### BRIEF DESCRIPTION OF THE DRAWINGS

FIG. 1 is a side view of a yieldable mailbox fixture assembly, which includes a base post coupled with a support post through a yieldable assembly.

FIG. 2a is a perspective view of one embodiment of a yieldable mailbox fixture assembly.

FIGS. 2b, 2c and 2d are front, side and back views, respectively, of the yieldable mailbox fixture assembly of FIG. 2a.

FIG. 3a is a perspective view of another embodiment of a yieldable mailbox fixture assembly having a lamp.

FIGS. 3b, 3c and 3d are front, side and back views, respectively, of the yieldable mailbox fixture assembly of FIG. 3a.

FIG. 4 is a perspective view of another embodiment of a yieldable mailbox fixture assembly having a lamp.

FIG. 5 is a perspective view of a yieldable mailbox fixture assembly having a removeable lamp.

FIGS. 6a, 6b and 6c are front, back and side views, respectively, of a yieldable fixture assembly having a sign.

FIG. 7 is a perspective view of a yieldable fixture assembly having a sign.

FIGS. 8a, 8b and 8c are partial cut-away views of one embodiment of a support post assembly coupled to a base post through a yieldable assembly.

FIGS. 8d and 8e are top and bottom perspective views of a housing included with the support post assembly of FIGS. 8a, 8b and 8c.

FIG. 8f is a top view of an upwardly facing opening of a base post of FIGS. 8a, 8b and 8c.

FIG. 8g is a perspective view of a rigid fastener included with the yieldable assembly of FIGS. 8a, 8b and 8c.

FIG. 8h is a perspective view of a spring included with the yieldable assembly of FIGS. 8a, 8b and 8c.

FIG. 8i is a perspective view of a nut included with the yieldable assembly of FIGS. 8a, 8b and 8c.

FIGS. 8j and 8k are perspective views of washers included with the yieldable assembly of FIGS. 8a, 8b and 8c.

FIG. 8l is a side view of the rigid fastener of FIG. 8g extending through the spring of FIG. 8h.

FIG. 9a is an exploded view of a yieldable mailbox fixture assembly having a lamp.

FIG. 9b is an exploded close-up view of the yieldable assembly of FIG. 9a.

FIGS. 9c, 9d and 9e are cut-away views of the yieldable assembly of FIG. 9a.

FIG. 10 is a cut-away side view of another embodiment of a yieldable assembly.

FIG. 11 is a cut-away side view of another embodiment of a yieldable assembly.

FIGS. 12a and 12b are front views of different embodiments of a yieldable fixture assembly having an advertising sign.

FIGS. 12c and 12d are front views of different embodiments of a yieldable fixture assembly having an advertising sign and light.

FIGS. 13a and 13b are front views of different embodiments of a yieldable fixture assembly having an advertising sign.

FIGS. 13c and 13d are front views of different embodiments of a yieldable fixture assembly having an advertising sign and light.

FIG. 14 is a front view of a yieldable fixture assembly.

FIG. 15a is a perspective view of one embodiment of a yieldable mailbox fixture assembly.

FIGS. 15b, 15c and 15d are front, side and back views, respectively, of the yieldable mailbox fixture assembly of FIG. 15a.

FIG. 16a is a perspective view of another embodiment of a yieldable mailbox fixture assembly with a lamp.

FIGS. 16b, 16c and 16d are front, side and back views, respectively, of the yieldable mailbox fixture assembly of FIG. 16a.

FIGS. 17a, 17b and 17c are flow diagrams of a method of manufacturing a fixture assembly.

FIGS. 18a, 18b and 18c are flow diagrams of a method of installing a fixture assembly.

FIGS. 19a, 19b and 19c are flow diagrams of a method of balancing a fixture assembly.

### DETAILED DESCRIPTION OF THE INVENTION

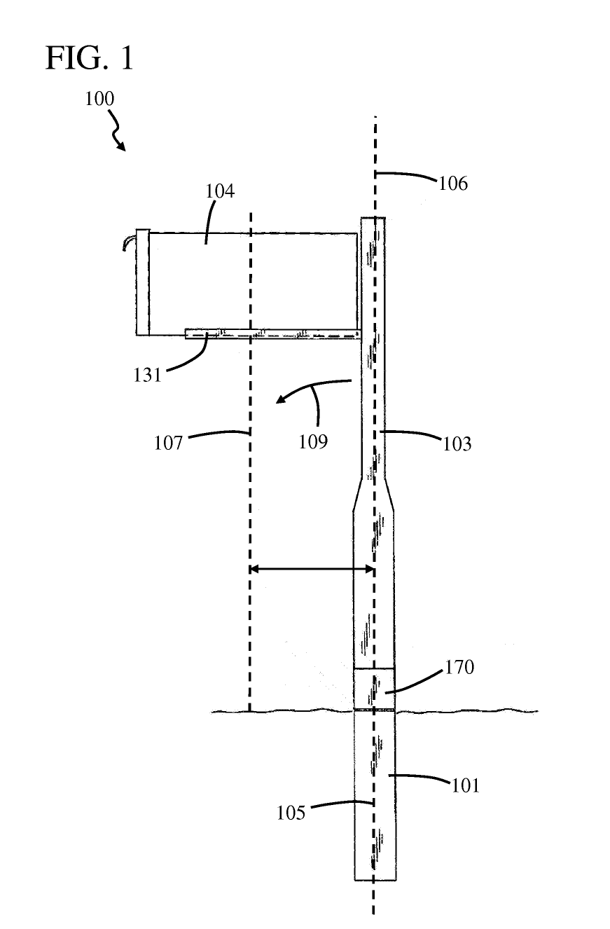

FIG. 1 is a side view of a yieldable mailbox fixture assembly 100, which includes a base post 101 coupled with a support post 103 through a yieldable assembly 170. Base post 101 extends through the ground, and yieldable assembly 170 and support post 103 extend above the ground. Base post 101 is typically driven into the ground to provide support for support post 103. Yieldable mailbox fixture assembly 100 includes a mailbox support plate 131 coupled with support post 103, and a mailbox 104 carried by mailbox support plate 131.

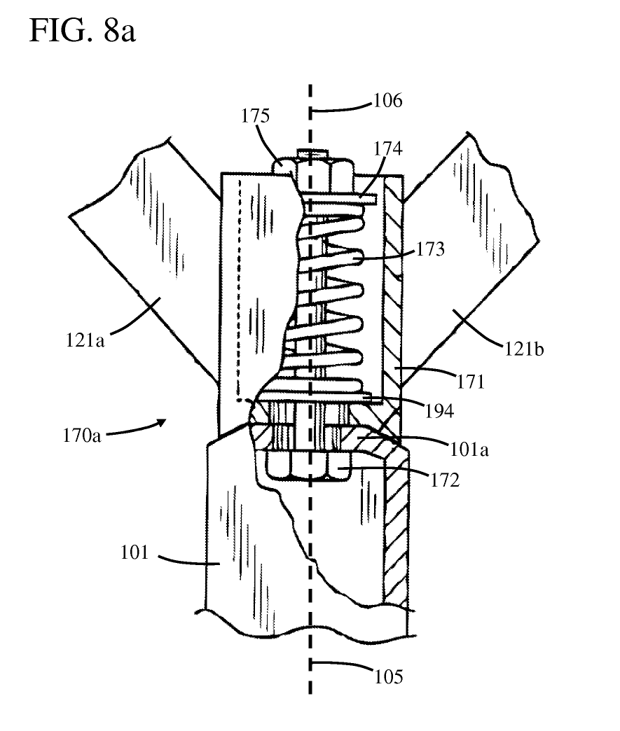

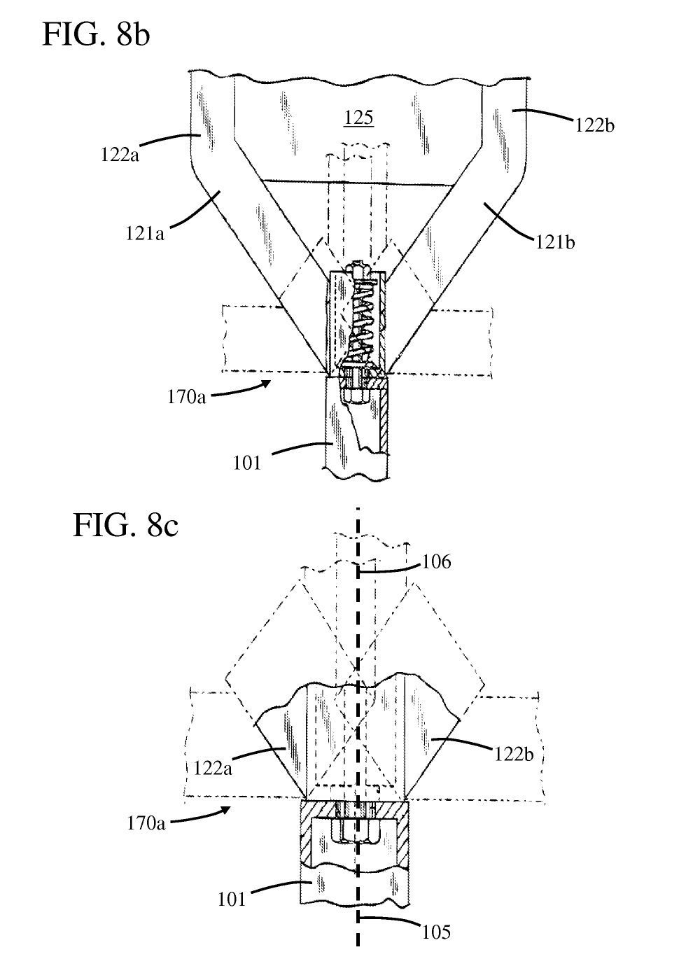

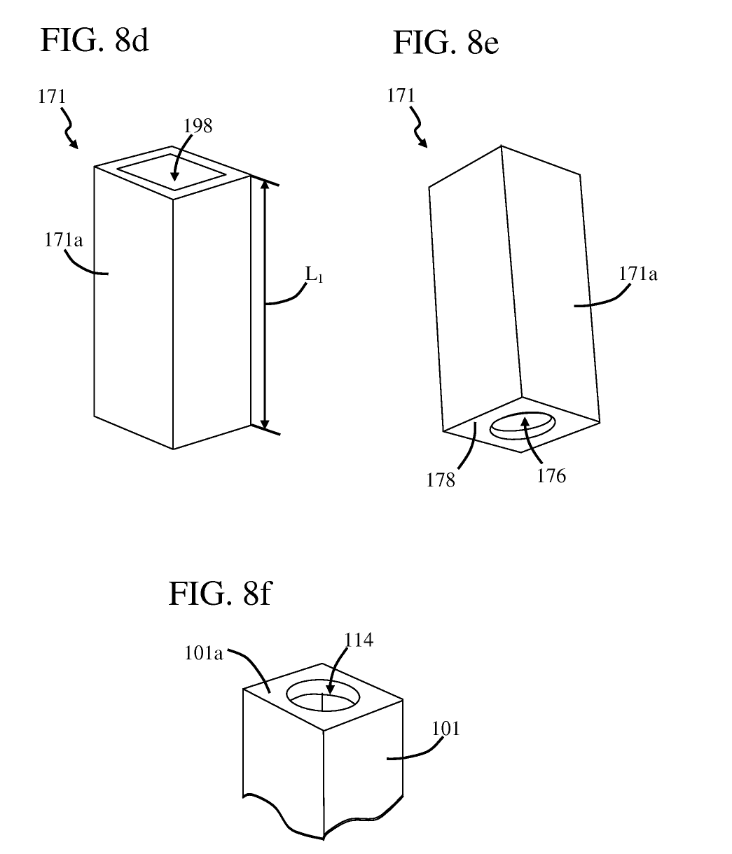

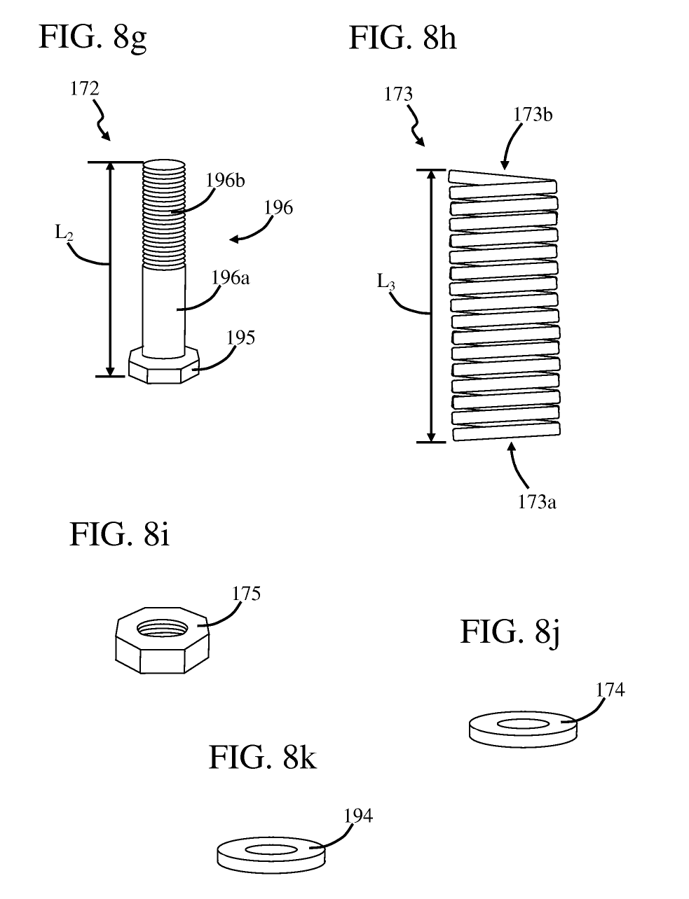

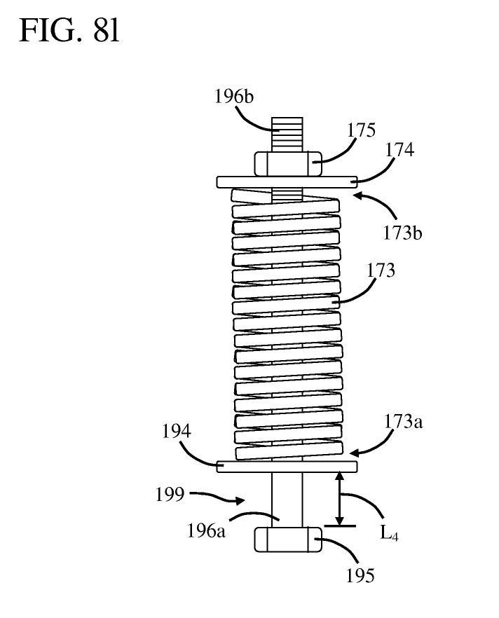

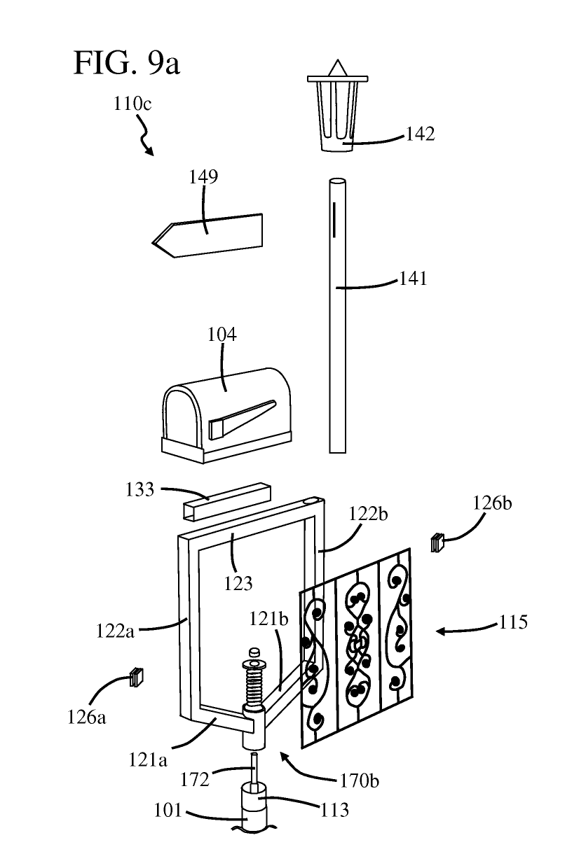

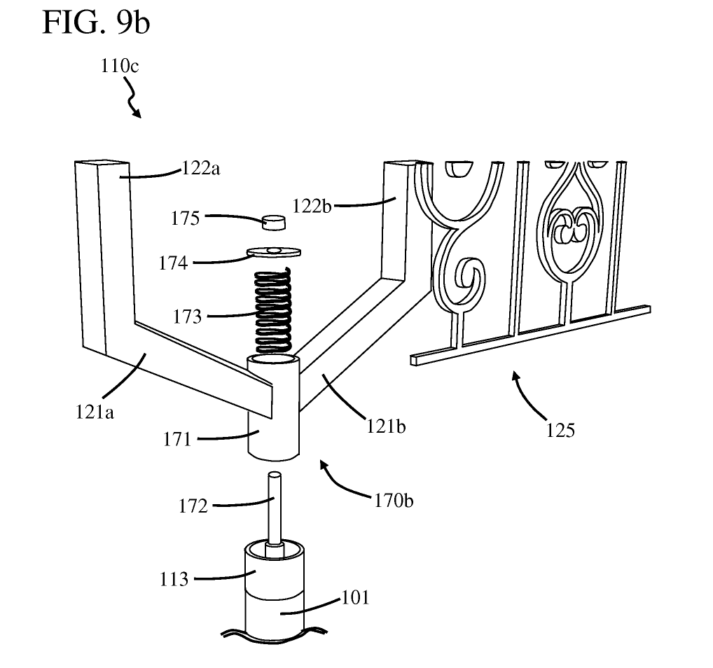

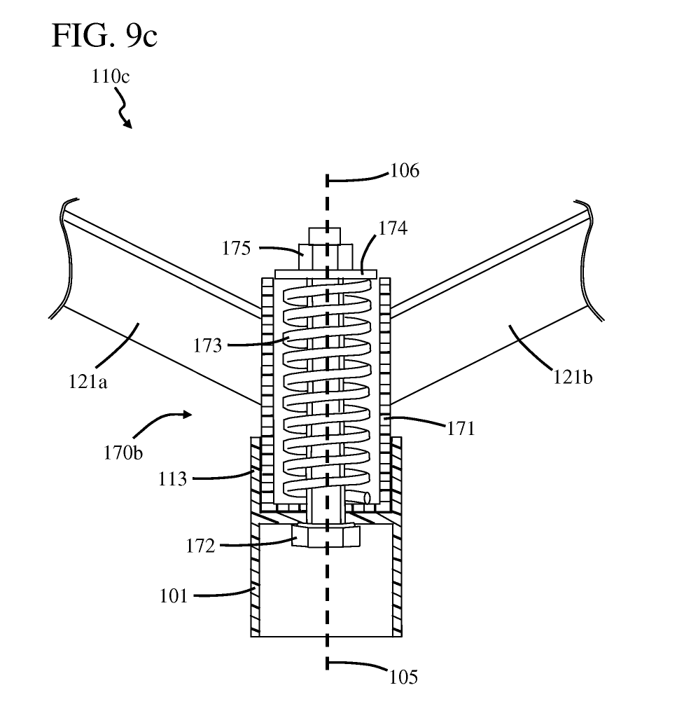

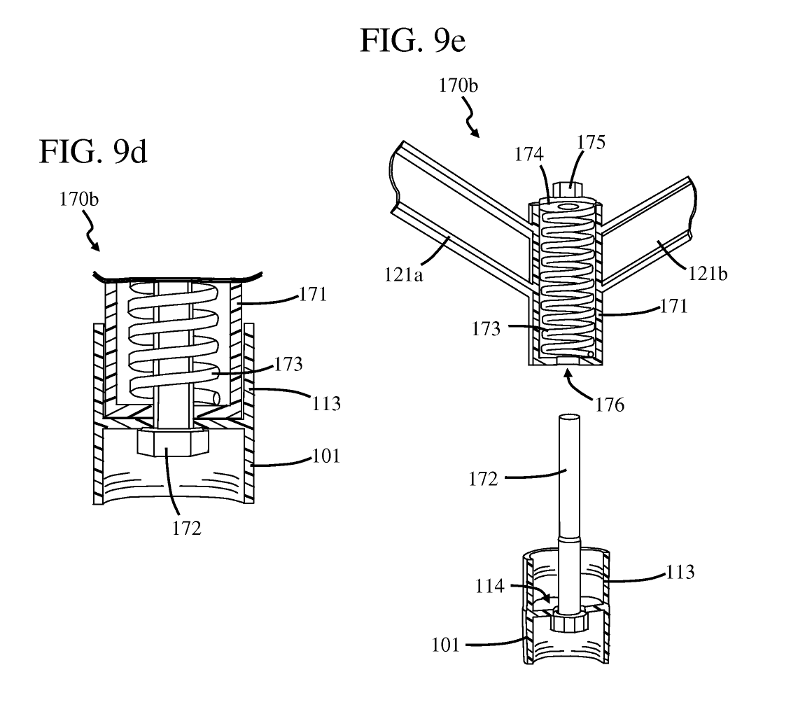

It should be noted that yieldable assembly 170 of yieldable mailbox fixture assembly 100 can include any of the yieldable assemblies disclosed herein. In one particular embodiment, yieldable assembly 170 of yieldable mailbox fixture assembly 100 includes yieldable assembly 170a, which is discussed with FIGS. 8a, 8b and 8c. In another particular embodiment, yieldable assembly 170 of yieldable mailbox fixture assembly 100 includes yieldable assembly 170b, which is discussed with FIGS. 9a, 9b and 9c.

Yieldable assembly 170 allows support post 103 to yield relative to base post 101 in response to a force applied to it or mailbox 104. Support post 103 tilts relative to base post 101 when support post 103 yields relative to base post 101. In this way, support post 103 and mailbox 104 are less likely to be damaged in response to a force applied to them. Support post 103 is shown in an untilted and unyielded position in FIG. 1, wherein a reference line 106 is parallel to a reference line 105. Reference lines 105 and 106 extend through base post 101 and support post 103, respectively. Support post 103 is in a tilted position when reference line 106 is not parallel to reference line 105. Reference line 106 is at an angle relative to reference line 105 when reference line 106 is not parallel to reference line 105. It should be noted that yieldable assembly 170 allows support post 103 to be repeatably moveable between the untilted and tilted positions. It should be noted that the untilted position is sometimes referred to as an upright position.

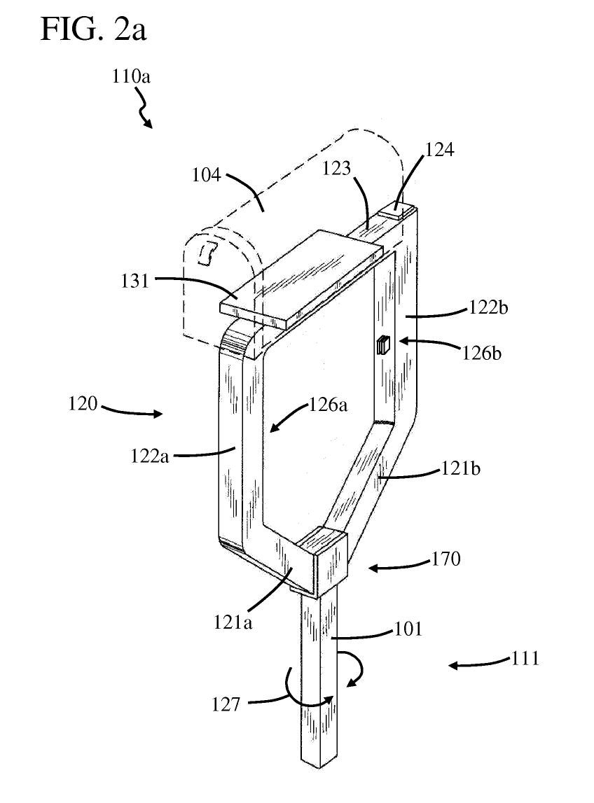

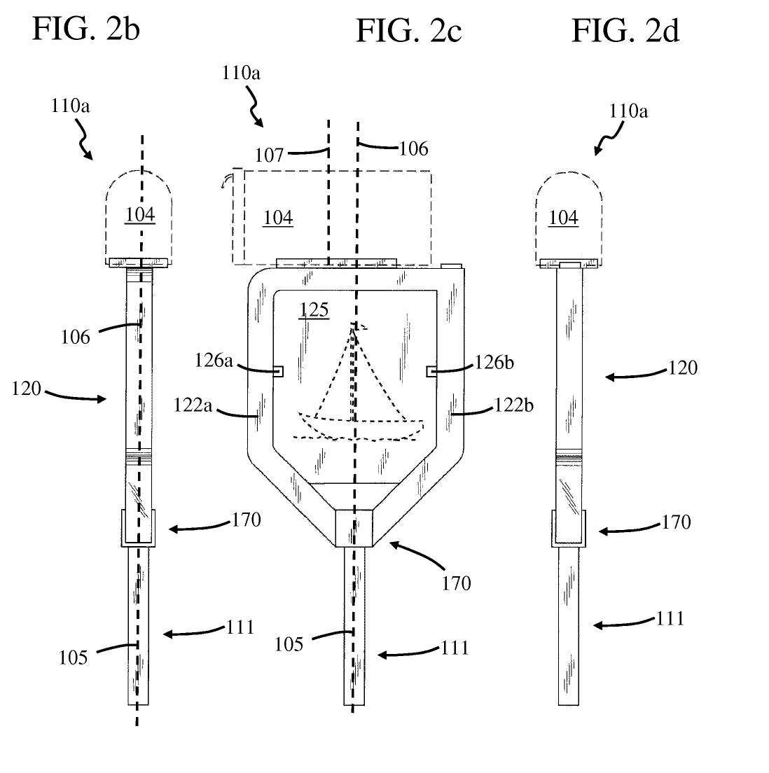

In this embodiment, reference lines 105 and 106 are aligned with each other because support post 103 extends upwardly from, and is aligned with, base post 101. However, a reference line 107, which extends through mailbox 104, is spaced apart from reference lines 105 and 106 because mailbox 104 is offset from base post 101 and support post 103. Mailbox 104 can undesirably tilt support post 103 in a direction 109 because it is offset from base post 101 and support post 103. Further, mailbox 104 can undesirably rotate and torque support post 103 in direction 109 because it is offset from base post 101 and support post 103. Hence, mailbox 104 can undesirably move support post 103 from the untilted to the tilted position because mailbox 104 can rotate and torque support post 103 in direction 109. In this way, support post 103 can undesirably move from the untilted to the tilted position in the absence of an applied force because mailbox 104 is offset from base post 101 and support post 103. It should be noted that, in some situations, support post 103 can tilt side-to-side, which is in a direction perpendicular to that shown in FIG. 1. The side-to-side direction is shown in FIGS. 2b and 2d.

FIG. 2a is a perspective view of one embodiment of a yieldable mailbox fixture assembly 110a. FIGS. 2b, 2c and 2d are front, side and back views, respectively, of yieldable mailbox fixture assembly 110a. More information regarding yieldable mailbox fixture assembly 110a can be found in U.S. Pat. No. D549,924, the contents of which are incorporated by reference as though fully set forth herein. In this embodiment, yieldable mailbox fixture assembly 110a includes a base post assembly 111 coupled with a support post assembly 120 through yieldable assembly 170.

It should be noted that yieldable assembly 170 of yieldable mailbox fixture assembly 110a can include any of the yieldable assemblies disclosed herein. In one particular embodiment, yieldable assembly 170 of yieldable mailbox fixture assembly 110a includes yieldable assembly 170a, which is discussed with FIGS. 8a, 8b and 8c. In another particular embodiment, yieldable assembly 170 of yieldable mailbox fixture assembly 110a includes yieldable assembly 170b, which is discussed with FIGS. 9a, 9b and 9c.

Base post assembly 111 can include many different components, but here it includes base post 101. Base post 101 is typically driven into the ground to provide support for support post assembly 120. Support post assembly 120 carries mailbox 104, which is coupled to mailbox support plate 131.

Yieldable assembly 170 allows support post assembly 120 to repeatably move between untilted and tilted positions in response to an applied force. The untilted and tilted positions are discussed in more detail above with FIG. 1. Further, more information regarding the untilted and tilted positions is provided in the above-referenced U.S. patent application Ser. No. 11/487,674.

Support post assembly 120 generally moves from the untilted to the tilted positions in response to the applied force. The force can be applied in many different ways, such as by engaging mailbox 104 or support post assembly 120 with a vehicle. In these situations, it is desirable for support post assembly 120 to move from the untilted to the tilted positions in response to being engaged by the vehicle to reduce the amount of damage to yieldable mailbox fixture assembly 110a. It should be noted that support post assembly 120 is typically capable of rotating, in a direction 127, about reference line 106 relative to base support structure 111. In this way, support post assembly 120 can also rotate in response to the applied force.

It is generally desirable, however, to have support post assembly 120 remain in the untilted position in the absence of the applied force. Hence, it is desirable to balance support post assembly 120, as well as the components carried by it, such as mailbox 104, so that support post assembly 120 is less likely to undesirably move from the untilted position to the tilted position in the absence of the applied force. Support post assembly 120 can be balanced in many different ways, one of which will be discussed in more detail presently.

In this embodiment, support post assembly 120 includes opposed angled post members 121a and 121b extending upwardly from yieldable assembly 170. Post members 121a and 121b are angled post members because they extend at a non-zero angle relative to base post 101. In this way, post members 121a and 121b do not extend parallel with base post 101. Opposed angled post members 121a and 121b are chosen to restrict the movement of support post assembly 120 from the untilted position to the tilted position. In this way, mailbox 104 is carried by support post assembly 120 so it is balanced over base post assembly 111. Opposed angled post members 121a and 121b can be chosen to restrict the movement of support post assembly 120 from the untilted position to the tilted position in many different ways.

In some embodiments, opposed angled post members 121a and 121b are chosen so that the center of mass of support post assembly 120 is driven to be aligned with reference line 105. In one example, the weights of angled post members 121a and 121b are chosen to drive the center of mass of support post assembly 120 to be aligned with reference line 105 (FIG. 2c). The center of mass of support post assembly 120 is moved towards angled post member 122a in response to increasing the weight of angled post member 122a. Further, the center of mass of support post assembly 120 is moved towards angled post member 122b in response to increasing the weight of angled post member 122b. In this way, the center of mass of support post assembly 120 can be adjusted relative to reference line 105 in response to adjusting the weights of angled post members 121a and 121b. Further, the center of mass of support post assembly 120 can be adjusted relative to base post assembly 111 in response to adjusting the weights of angled post members 121a and 121b.

In this embodiment, support post assembly 120 includes opposed upright post members 122a and 122b extending upwardly from angled post members 121a and 121b, respectively. In some embodiments, post members 122a and 122b extend at an angle to base post 101. However, in this embodiment, post members 122a and 122b extend parallel with base post 101. Opposed upright post members 122a and 122b are chosen to restrict the movement of support post assembly 120 from the untilted position to the tilted position. In this way, mailbox 104 is carried by support post assembly 120 so it is balanced over base post assembly 111. Opposed upright post members 122a and 122b can be chosen to restrict the movement of support post assembly 120 from the untilted position to the tilted position in many different ways.

For example, opposed upright post members 122a and 122b are positioned to restrict movement of support post assembly 120 from the untilted position to the tilted position. Opposed upright post members 122a and 122b are chosen so that the center of mass of support post assembly 120 is driven to be aligned with reference line 105. In one example, the weights of upright post members 122a and 122b are chosen to drive the center of mass of support post assembly 120 to be aligned with reference line 105. The center of mass of support post assembly 120 is moved towards upright post member 122a in response to increasing the weight of upright post member 122a. Further, the center of mass of support post assembly 120 is moved towards upright post member 122b in response to increasing the weight of upright post member 122b. In this way, the center of mass of support post assembly 120 can be adjusted relative to reference line 105 in response to adjusting the weights of upright post members 122a and 122b. The center of mass of support post assembly 120 can be adjusted relative to base post assembly 111 in response to adjusting the weights of upright post members 122a and 122b.

Hence, opposed angled post members 121a and 121b, as well as opposed upright members 122a and 122b, are used to balance mailbox 104 over base post assembly 111. Opposed angled post members 121a and 121b, as well as opposed upright members 122a and 122b, are positioned to bias support post assembly 120 to the untilted position. Further, opposed angled post members 121a and 121b, as well as opposed upright members 122a and 122b, are used to balance mailbox 104 over base post assembly 111. Opposed angled post members 121a and 121b, as well as opposed upright members 122a and 122b, are positioned to restrict movement of support post assembly 120 from an untilted position to a tilted position. Further, opposed angled post members 121a and 121b, as well as opposed upright members 122a and 122b, are positioned to bias support post assembly 120 to the untilted position. In this way, support post assembly 120 is balanced so that mailbox 104 is balanced over base post assembly 111.

In this embodiment, support post assembly 120 includes a horizontal post member 123 which extends between upright post members 122a and 122b. Horizontal post member 123 is connected to ends of upright post members 122a and 122b opposed to angled post members 121a and 121b. Further, mailbox support plate 131 is carried by horizontal post member 123, wherein mailbox 104 is carried by mailbox support plate 131.

Horizontal post member 123 is positioned to restrict movement of support post assembly 120 from the untilted position to the tilted position. In this way, mailbox 104 is carried by support post assembly 120 so it is balanced over base post assembly 111. Horizontal post member 123 is chosen so that the center of mass of support post assembly 120 is driven to be aligned with reference line 105. In one example, the weight distribution of horizontal post member 123 is chosen to drive the center of mass of support post assembly 120 to be aligned with reference line 105 (FIG. 2c). The center of mass of support post assembly 120 is moved towards upright post member 122a in response to increasing the weight of horizontal post member 123 proximate to upright post member 122a. Further, the center of mass of support post assembly 120 is moved towards upright post member 122b in response to increasing the weight of horizontal post member 123 proximate to upright post member 122b. In this way, the center of mass of support post assembly 120 can be adjusted relative to reference line 105 in response to adjusting the weight distribution of horizontal post member 123. Further, the center of mass of support post assembly 120 can be adjusted relative to base post assembly 111 in response to adjusting the weight distribution of horizontal post member 123.

In some embodiments, support post assembly 120 carries a reinforcement member 125 (FIG. 2c). Reinforcement member 125 can be of many different types, such as a reinforcement display piece, but here it is embodied as a reinforcement plate 125a. In this embodiment, reinforcement member 125 extends between upright post members 122a and 122b and horizontal post member 123. Reinforcement member 125 provides many different functions. For example, reinforcement member 125 provides reinforcement for support post assembly 120 to make it sturdier. Reinforcement member 125 reinforces support post assembly 120 to make it sturdier because it restricts the ability of upright post members 122a and 122b to move towards and away from each other, such as when a force is applied thereto.

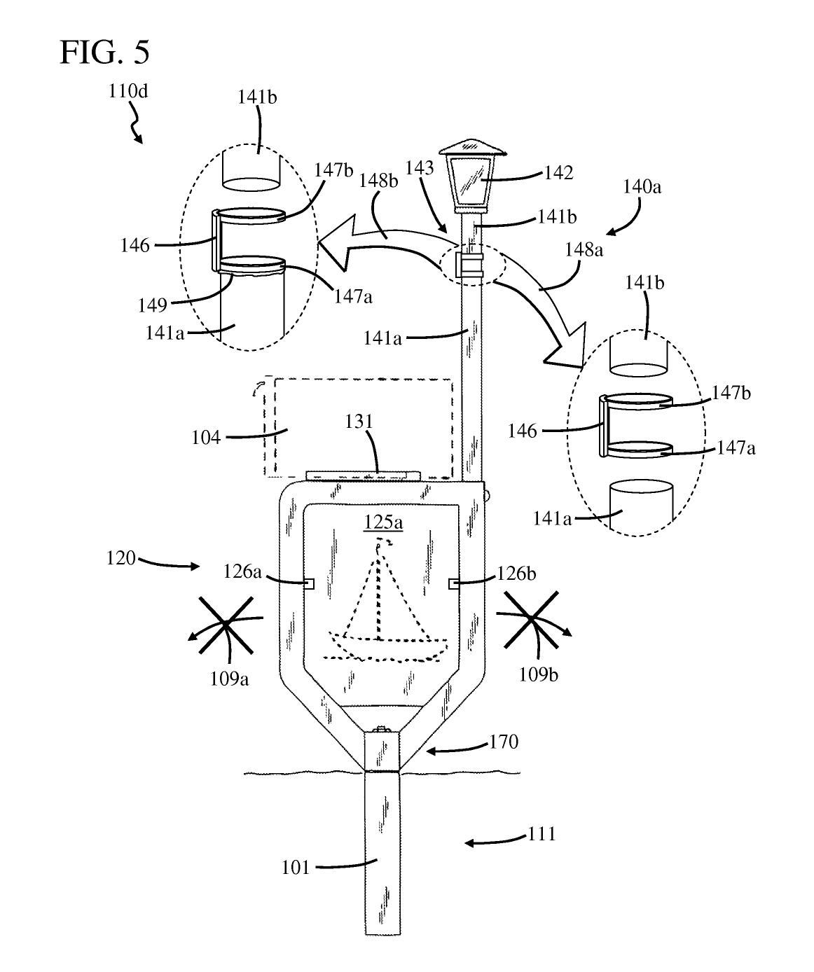

Reinforcement member 125 also provides additional balancing to balance support post assembly 120 over base post assembly 111. For example, the center of mass of support post assembly 120 is moved towards upright post member 122a in response to increasing the weight of reinforcement member 125 proximate to upright post member 122a. Further, the center of mass of support post assembly 120 is moved towards upright post member 122b in response to increasing the weight of reinforcement member 125 proximate to upright post member 122b. In this way, the center of mass of support post assembly 120 can be adjusted relative to reference line 105 in response to adjusting the weight of reinforcement member 125. Further, the center of mass of support post assembly 120 can be adjusted relative to base post assembly 111 in response to adjusting the weight of reinforcement member 125. More information regarding adjusting the weight of reinforcement member 125 is provided in more detail below with FIGS. 5a-5g.

Support post assembly 120 can carry reinforcement member 125 in many different ways. In this embodiment, yieldable mailbox fixture assembly 110a includes brackets 126a and 126b which hold reinforcement member 125 to opposed upright members 122a and 122b, respectively. Brackets 126a and 126b allow reinforcement member 125 to be repeatably coupled to and decoupled from support post assembly 120 in a repeatable manner. It should be noted that reinforcement member 125 can be held to support post assembly 120 in many other ways, such as by using bolts or other types of fasteners. More information regarding different ways in which reinforcement member 125 can be coupled to support post assembly 120 is provided in U.S. Pat. Nos. 3,940,900, 4,059,923, 4,634,157, 5,283,975, 6,578,664, 7,152,368, as well as in U.S. Design Pat. Nos. D288,854 and D288,367.

In general, however, reinforcement member 125 is held to support post assembly 120 in a repeatably removeable manner. In this way, reinforcement member 125 can be removed and replaced with another reinforcement member. Hence, the reinforcement members carried by support post assembly 120 are interchangeable. This is useful so that the balance of support post assembly 120 can be adjusted in response to removing one reinforcement member 125 and replacing it with another reinforcement member having a different weight. This is also useful so that the balance of support post assembly 120 can be adjusted in response to removing one reinforcement member 125 and replacing it with another reinforcement member having a different weight distribution. In this way, the center of mass of support post assembly 120 can be adjusted in response to interchanging reinforcement members.

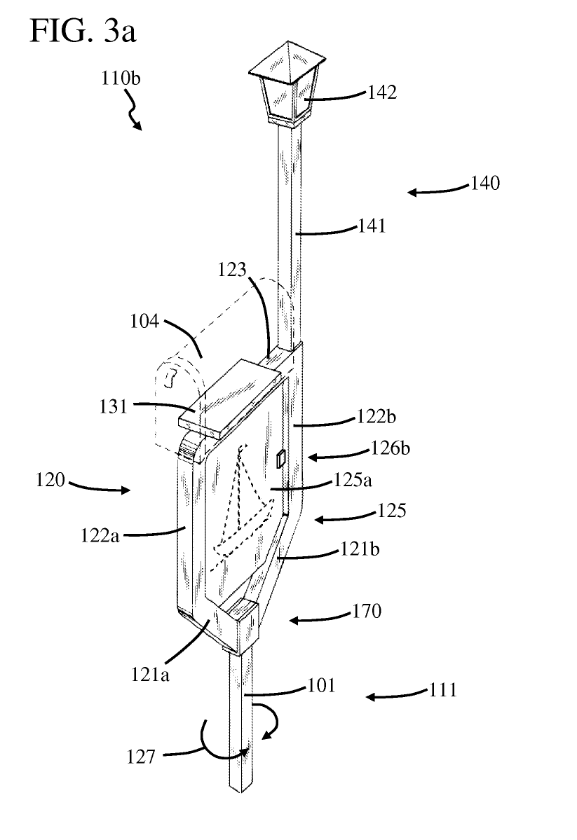

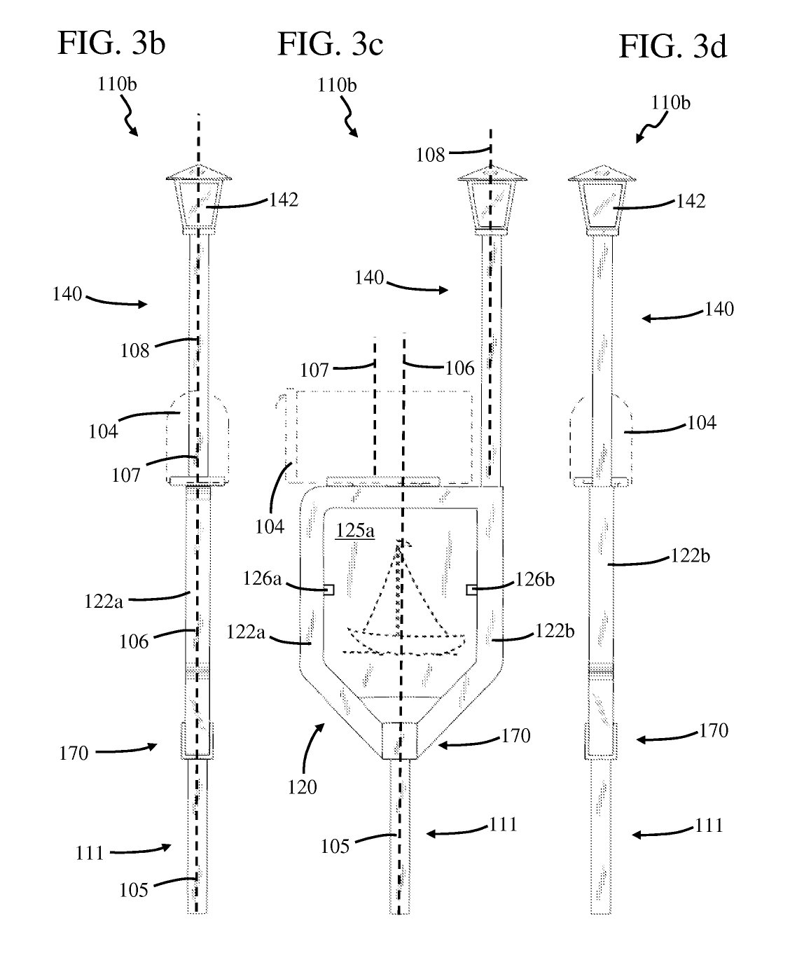

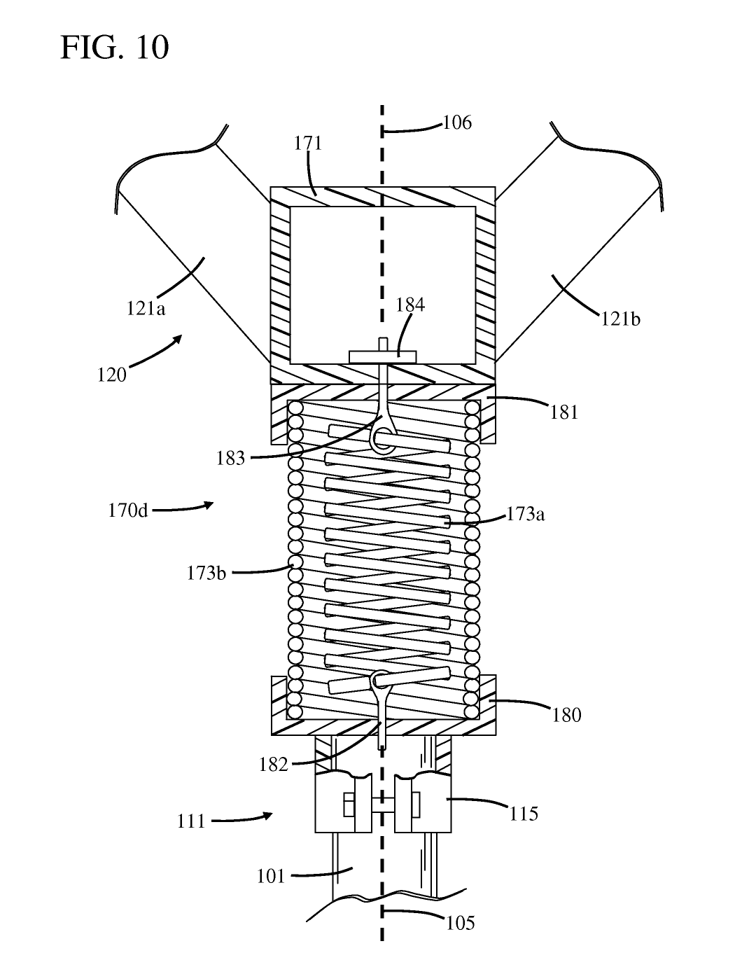

FIG. 3a is a perspective view of one embodiment of a yieldable mailbox fixture assembly 110b having a lamp. FIGS. 3b, 3c and 3d are front, side and back views, respectively, of yieldable mailbox fixture assembly 110b. More information regarding yieldable mailbox fixture assembly 110b can be found in U.S. Pat. No. D549,923, the contents of which are incorporated by reference as though fully set forth herein. In this embodiment, yieldable mailbox fixture assembly 110b includes yieldable mailbox fixture assembly 110a. Further, yieldable mailbox fixture assembly 110b includes a lamp fixture assembly 140 carried by support post assembly 120. Lamp fixture assembly 140 can be carried by support post assembly 120 in many different ways. In this embodiment, lamp fixture assembly 140 extends upwardly from upright post member 122b. In particular, lamp fixture assembly 140 includes a lamp post 141 which extends through an upwardly facing opening 124a (FIG. 10a) of upright post member 122b. Upwardly facing opening 124a of upright post member 122b is covered by a cap 124 in FIG. 2a. Lamp fixture assembly 140 includes a lamp 142 carried by lamp post 141, wherein lamp 142 emits light in response to being powered. Lamp 142 can be powered in many different ways. For example, in some embodiments, light 142 is connected to a power source (not shown) through a power chord (not shown). In other embodiments, light 167 is connected to a battery or a solar power source. Examples of lamps and lamp posts are disclosed in U.S. Pat. No. 6,017,131.

Lamp fixture assembly 140 provides many different functions. For example, lamp fixture assembly 140 provides light, which is emitted by lamp 142. Lamp fixture assembly 140 also provides additional balancing to balance support post assembly 120 over base post assembly 111. The center of mass of support post assembly 120 is moved towards upright post member 122a in response to decreasing the weight of lamp fixture assembly 140. Further, the center of mass of support post assembly 120 is moved towards upright post member 122b in response to increasing the weight of lamp fixture assembly 140. Hence, the center of mass of support post assembly 120 can be adjusted relative to reference line 105 in response to adjusting the weight of lamp fixture assembly 140. In this way, support post assembly 120 is balanced so that mailbox 104 is balanced over base post assembly 111.

It should be noted that the weight distribution of reinforcement member 125 can be adjusted, as described above, to compensate for the weight of lamp fixture assembly 140 so that support post assembly 120 is balanced over base post assembly 111. For example, the center of mass of support post assembly 120 is moved away from lamp fixture assembly 140 in response to increasing the weight of reinforcement member 125 proximate to upright post member 122a. Further, the center of mass of support post assembly 120 is moved towards lamp fixture assembly 140 in response to increasing the weight of reinforcement member 125 proximate to upright post member 122b. Hence, the center of mass of support post assembly 120 can be adjusted relative to reference line 105 and lamp fixture assembly 140 in response to adjusting the weight distribution of reinforcement member 125.

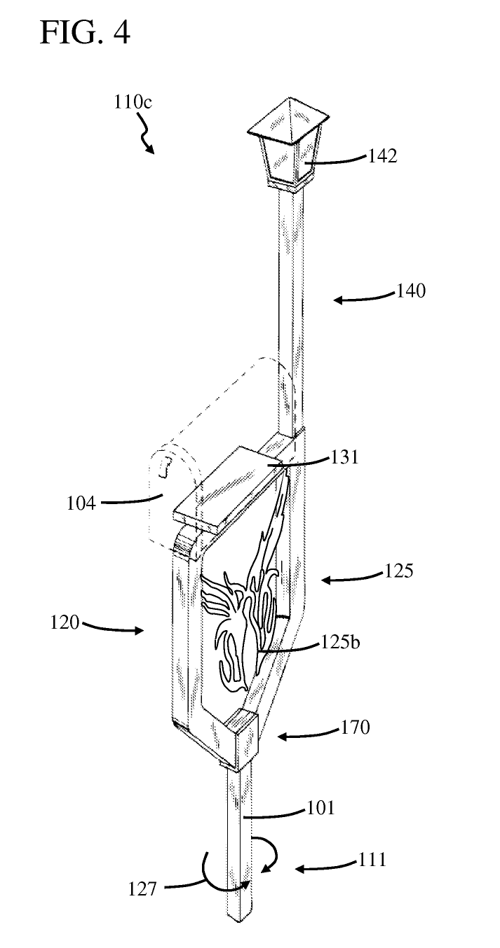

FIG. 4 is a perspective view of yieldable mailbox fixture assembly 110c having a lamp. In this embodiment, yieldable mailbox fixture assembly 110c includes reinforcement member 125 which is embodied as a reinforcement display piece 125b. Reinforcement display piece 125b can be manufactured in many different ways. In general, reinforcement display piece 125b is manufactured by cutting it from a larger piece of material, such as a sheet of steel or a sheet of another rigid material. Reinforcement display piece 125b can be cut from the larger piece of material in many different ways, such as by using a laser or plasma beam. Machines that are capable of cutting pieces of material include Computer Numerical Control (CNC) cutting machines, laser cutters and plasma cutters, among others. Reinforcement display piece 125b are provided by many different manufacturers, such as Texas Metal Industries of Mesquite, Tex. The larger piece of material can be provided with a desired weight and thickness distribution so that reinforcement display piece 125b is cut with the desired weight distribution to balance support post assembly 120 with base post assembly 111. Reinforcement member 125 can also be manufactured using the technology as disclosed in U.S. Pat. Nos. 4,667,935, 6,701,608 and 7,121,004, the contents of which are incorporated by reference as though fully set forth herein.

Reinforcement display piece 125b can be coated with a material after it is cut from the larger piece of material. It is desirable to coat reinforcement display piece 125b for many different reasons, such as to protect it from the weather and to provide it with a desired finish. It may also be desirable to coat reinforcement display piece 125b to adjust its center of mass so that it drives the center of mass of support post assembly 120 to a desired location relative to reference line 105.

Reinforcement display piece 125b is positioned to provide support to support post assembly 120. Further, reinforcement display piece 125b is positioned to balance support post assembly 120 over base post assembly 111. Reinforcement display piece 125b is shaped to adjust the center of mass of support post assembly 120 by a desired amount, as will be discussed in more detail presently.

FIG. 5 is a perspective view of a yieldable mailbox fixture assembly 110d having a removeable lamp. In this embodiment, yieldable mailbox fixture assembly 110d includes yieldable mailbox fixture assembly 110a, which is discussed above with FIG. 2a. Further, yieldable mailbox fixture assembly 110b includes a lamp fixture assembly 140a coupled to support post assembly 120. In this embodiment, lamp fixture assembly 140a includes lower and upper lamp posts 141a and 141b which are coupled together through a lamp post bracket assembly 143, wherein lamp 142 is carried by upper lamp post 141b. Lamp post bracket assembly 143 allows upper lamp post 141b to be repeatably coupled to and decoupled from lower lamp post 141a. In this way, upper lamp post 141b and lamp 142 can be decoupled from lamp fixture assembly 140a and replaced with another upper lamp post and lamp.

Lamp post bracket assembly 143 can be of many different types. In this embodiment, lamp post bracket assembly 143 includes clamps 147a and 147b coupled together with an arm 146. Clamps 147a and 147b can be of many different types, such as hose clamps. Examples of hose clamps are disclosed in U.S. Pat. Nos. 4,638,531, 5,185,907 and 5,177,836, the contents of which are incorporated by reference as though fully set forth herein.

In some embodiments, such as the embodiment indicated by an indication arrow 148a, lamp post bracket assembly 143 can be repeatably coupled to and decoupled from lower and upper lamp posts 141a and 141b. In particular, clamps 147a and 147b can be repeatably coupled to and decoupled from lower and upper lamp posts 141a and 141b, respectively. In the embodiment indicated by an indication arrow 148b, lamp post bracket assembly 143 can be repeatably coupled to and decoupled from upper lamp post 141b. However, lamp post bracket assembly 143 is fixedly attached to lower lamp post 141a. Lamp post bracket assembly 143 can be fixedly attached to lower lamp post 141a in many different ways. In this embodiment, clamp 147a is welded to lower lamp post 141a with a weldment 149.

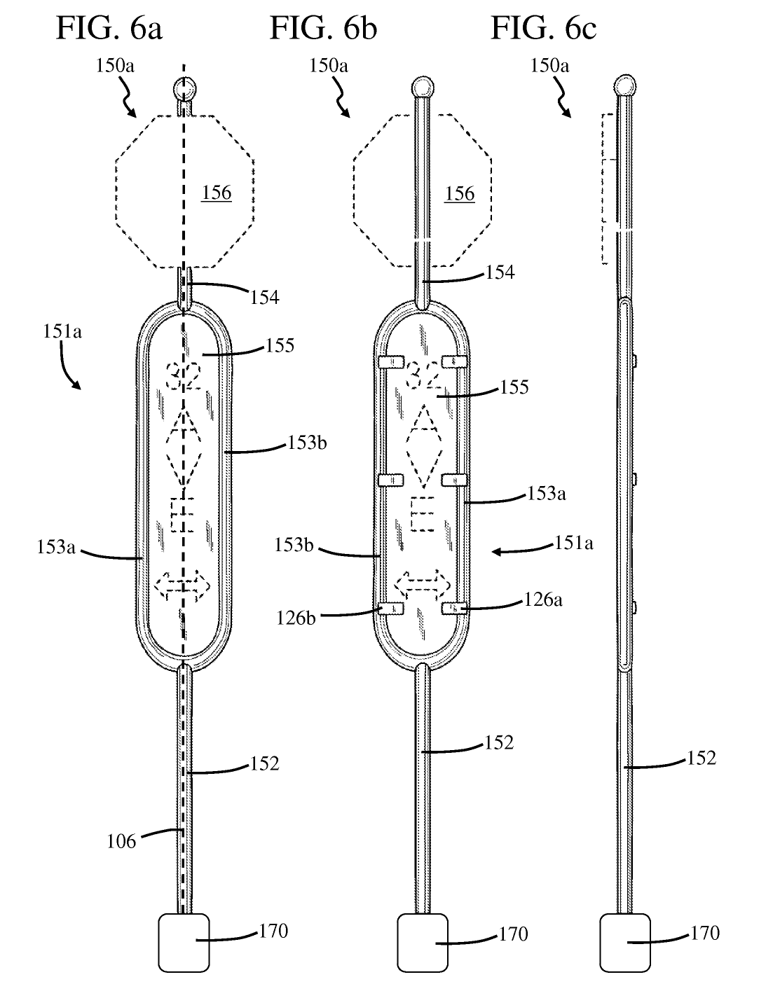

FIGS. 6a, 6b and 6c are front, back and side views, respectively, of a yieldable sign fixture assembly 150a. More information regarding yieldable sign fixture assembly 150a can be found in U.S. Pat. No. D566,778, the contents of which are incorporated by reference as though fully set forth herein. In this embodiment, yieldable sign fixture assembly 150a includes a support post assembly 151a coupled with a base post assembly (not shown) through yieldable assembly 170. Support post assembly 151a includes a lower sign post 152 extending upwardly from yieldable assembly 170, and opposed upright post members 153a and 153b extending upwardly from lower sign post 152. Support post assembly 151a includes an upper sign post 154 extending upwardly from opposed upright post members 153a and 153b. A traffic sign 156 is coupled to upper sign post 154, and a traffic sign 155 is positioned so it extends between opposed upright post members 153a and 153b. Traffic signs 155 and 156 can display many different types of information, such as traffic commands like “STOP”, “YIELD” or “SLOW”, among others. In one particular embodiment, traffic sign 155 displays a street address and traffic sign 156 displays a traffic command.

Upright post members 153a and 153b are chosen to drive the center of mass of support post assembly 151a so it is aligned with reference line 105. There are many different ways in which upright post members 153a and 153b can be chosen to drive the center of mass of support post assembly 151a so it is aligned with reference line 105. For example, in one embodiment, the weight of upright post member 153a is chosen to be greater than the weight of upright post member 153b so that the center of mass of support post assembly 151a is driven towards upright post member 153a. In another embodiment, the weight of upright post member 153b is chosen to be greater than the weight of upright post member 153a so that the center of mass of support post assembly 151a is driven towards upright post member 153b. In this way, the center of mass of support post assembly 151a can be adjusted by adjusting the weights of upright post members 153a and 153b.

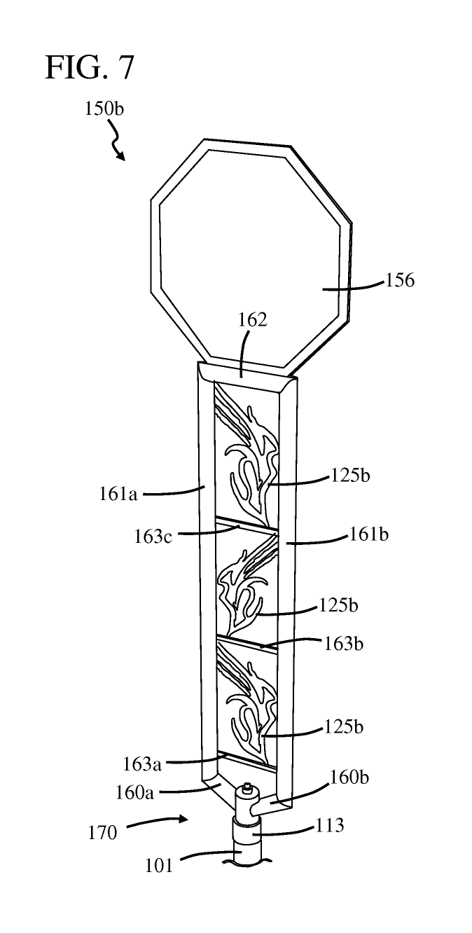

FIG. 7 is a perspective view of a yieldable sign fixture assembly 150b. More information regarding yieldable sign fixture assembly 150b can be found in U.S. patent application No. 29/286,032 filed on Apr. 23, 2007, the contents of which are incorporated by reference as though fully set forth herein. In this embodiment, yieldable sign fixture assembly 150b includes a support post assembly 151b coupled with base post assembly 101 through yieldable assembly 170. Support post assembly 151b includes opposed angled post members 160a and 160b which extend from yieldable assembly 170, and opposed upright post members 161a and 161b which extend upwardly from angled post members 160a and 160b, respectively. Support post assembly 151b includes a horizontal post member 162 which extends between opposed upright post members 161a and 161b at ends thereof opposed to the ends connected to angled post members 160a and 160b. Traffic sign 156 extends upwardly from horizontal post member 162. Support post assembly 151b includes cross-post members 163a, 163b and 163c which extends between opposed upright post members 161a and 161b, wherein cross-post members 163a, 163b and 163c are spaced apart from each other along the length of upright post members 161a and 161b.

In this embodiment, yieldable sign fixture assembly 150b includes a plurality of reinforcement members 125, which are embodied as display pieces 125a, 125b and 125c. Display piece 125a is positioned between cross-post members 163a and 163b, as well as opposed upright post members 161a and 161b. Display piece 125b is positioned between cross-post members 163b and 163c, as well as opposed upright post members 161a and 161b. Display piece 125c is positioned between cross-post member 163c and horizontal post member 162, as well as opposed upright post members 161a and 161b.

Angled post members 160a and 160b are chosen to drive the center of mass of support post assembly 151b so it is aligned with reference line 105. There are many different ways in which angled post members 160a and 160b can be chosen to drive the center of mass of support post assembly 151b so it is aligned with reference line 105. For example, in one embodiment, the weight of angled post member 160a is chosen to be greater than the weight of angled post member 160b so that the center of mass of support post assembly 151b is driven towards angled post member 160a. In another embodiment, the weight of angled post member 160b is chosen to be greater than the weight of angled post member 160a so that the center of mass of support post assembly 151b is driven towards angled post member 160b. In this way, the center of mass of support post assembly 151b can be adjusted by adjusting the weights of angled post members 160a and 160b.

Upright post members 161a and 161b are chosen to drive the center of mass of support post assembly 151b so it is aligned with reference line 105. There are many different ways in which upright post members 161a and 161b can be chosen to drive the center of mass of support post assembly 151b so it is aligned with reference line 105. For example, in one embodiment, the weight of upright post member 161a is chosen to be greater than the weight of upright post member 161b so that the center of mass of support post assembly 151b is driven towards upright post member 161a. In another embodiment, the weight of upright post member 161b is chosen to be greater than the weight of upright post member 161a so that the center of mass of support post assembly 151b is driven towards upright post member 161b. In this way, the center of mass of support post assembly 151b can be adjusted by adjusting the weights of upright post members 161a and 161b.

Display pieces 125a, 125b and 125c are chosen to drive the center of mass of support post assembly 151b so it is aligned with reference line 105. There are many different ways in which display pieces 125a, 125b and 125c can be chosen to drive the center of mass of support post assembly 151b so it is aligned with reference line 105. For example, in one embodiment, the weight of display pieces 125a, 125b and 125c are chosen to drive the center of mass of support post assembly 151b so it is aligned with reference line 105. In some embodiments, the orientation of display pieces 125a, 125b and 125c are chosen to drive the center of mass of support post assembly 151b so it is aligned with reference line 105. More information about choosing the weight and orientation of a display piece to drive the center of mass of support post assembly 151b so it is aligned with reference line 105 is provided in more detail above.

FIGS. 8a, 8b and 8c are partial cut-away views of one embodiment of a yieldable assembly 170a, wherein yieldable assembly 170a couples base post assembly 111 and support post assembly 120 together. In this embodiment, support post assembly 120 includes a housing 171, and angled post members 121a and 121b extend upwardly from housing 171.

FIGS. 8d and 8e are top and bottom perspective views, respectively, of housing 171. In this embodiment, housing 171 includes downwardly facing opening 176 and upwardly facing opening 198 which are positioned at its opposed ends, wherein opening 176 is positioned towards base post 101 and opening 198 is positioned away from base post 101. Housing 171 includes a housing end wall 178 (FIG. 8e) through which downwardly facing opening 176 extends, wherein housing end wall 178 is positioned towards base post 101. It should be noted that openings 176 and 198 can have many different shapes. In this embodiment, openings 176 and 198 are circular and rectangular in shape, respectively. Housing 171 includes a sidewall 171a which extends upwardly from housing end wall 178 and between openings 176 and 198, wherein sidewall 171a has a length L₁.

FIG. 8f is a perspective view of base post 101. In this embodiment, base post 101 includes an upwardly facing end wall 101a having an upwardly facing opening 114 extending therethrough. Upwardly facing opening 114 faces downwardly facing opening 176 of housing 171 (FIG. 8a). In this embodiment, upwardly facing opening 114 and downwardly facing opening 176 are adjacent to each other (FIG. 8a). Further, upwardly facing opening 114 and end wall 178 are adjacent to each other, and upwardly facing opening 114 and upwardly facing opening 198 are away from each other (FIG. 8a). End wall 178 extends between upwardly facing opening 114 and upwardly facing opening 198. Further, downwardly facing opening 176 is positioned between upwardly facing opening 114 and upwardly facing opening 198.

Yieldable assembly 170a includes a spring 173 with a rigid fastener 172 extending therethrough. Rigid fastener 172 and spring 173 are shown in perspective views in FIGS. 8g and 8h, respectively. In this embodiment, rigid fastener 172 is embodied as a bolt which includes a bolt head 195 with a bolt shaft 196 extending therefrom. Bolt shaft 196 includes a non-threaded portion 196a and threaded portion 196b. It should be noted that threaded portion 196b is for threadingly engaging a nut 175, which is shown in a perspective view in FIG. 8i.

As shown in FIG. 8h, spring 173 is a helical coil spring which includes opposed openings 173a and 173b. Spring 173 is positioned in housing 171 so that opening 173a is positioned towards downwardly facing opening 176 and opening 173b is positioned towards upwardly facing opening 198 (FIG. 8a). It should be noted that spring 173 has a length L₃, which is less than length L₁ of housing 171. Further, spring 173 has a length L₃, which is less than length L₂ of fastener 172.

It should also be noted that, in this embodiment, yieldable assembly 170a includes washers 174 and 194, which are shown in FIGS. 8j and 8k, respectively. In this embodiment, washers 174 and 194 are positioned proximate to openings 173b and 173a, respectively, of spring 173 (FIG. 8a). Washers 174 and 194 each include central openings through which bolt shaft 196 extends, as will be discussed in more detail presently. It should be noted that washer 194 is not included in some embodiments of yieldable assembly 170a.

As shown in FIGS. 8a and 8l, rigid fastener 172 extends through spring 173 so it extends through opposed openings 173a and 173b of spring 173. In particular, rigid fastener 172 extends through spring 173 so that non-threaded portion 196a extends through opening 173a and threaded portion 196b extends through opening 173b. In this way, rigid fastener 172 extends through spring 173.

As shown in FIGS. 8a and 8l, spring 173 extends between washers 194 and 174, and rigid fastener 172 extends through the central openings of washers 194 and 174. Further, nut 175 is threadingly engaged with threaded portion 196b of bolt shaft 196 and holds washer 174 to spring 173. It should be noted that spring 173 biases washer 174 against nut 175.

As shown in FIG. 8a, rigid fastener 172 extends through upwardly facing opening 114 of base post 101, as well as through a downwardly facing opening 114 of housing 171. Spring 173 is positioned proximate to downwardly facing opening 114 and receives rigid fastener 172. Hence, fastener 172 extends through opening 114 and spring 173. Washer 174 and nut 175 are coupled to rigid fastener 172 so that spring 173 extends between downwardly facing opening 114 and washer 174. In this way, spring 173 and rigid fastener 172 couple base post assembly 111 and support post assembly 120 together. Spring 173 and rigid fastener 172 allow support post assembly 120 to move between upright and tilted positions in response to a force applied thereto. The untilted position is shown in FIGS. 8b and 8c in solid lines, and the tilted position is shown in FIGS. 8b and 8c in broken lines.

It should be noted that washer 194 is spaced from bolt head 195 by a distance L₄, as shown in FIG. 8l. Distance L₄ is chosen so that upwardly facing end wall 101a and housing end wall 178 extend between washer 194 and bolt head 195. In this way, upwardly facing opening 114 and downwardly facing opening 176 extend between washer 194 and bolt head 195. In this embodiment, spring 173 biases washer 194 against end wall 178 and spring 173 biases bolt head 195 against end wall 101a. Spring 173 is biased between washers 174 and 194.

FIG. 9a is an exploded view of a yieldable fixture assembly 110e, which includes a yieldable assembly 170b, wherein yieldable assembly 170b couples base post assembly 111 and support post assembly 120 together. FIG. 9b is an exploded close-up view of yieldable assembly 170b, and FIGS. 9c, 9d and 9e are cut-away views of yieldable assembly 170b. In this embodiment, base post assembly 111 includes base post 101, and a cup 113 extending upwardly from base post 101, wherein cup 113 extends around upwardly facing opening 114 (FIG. 9e).

In this embodiment, support post assembly 120 includes housing 171 (FIG. 9b) and angled post members 121a and 121b which extend upwardly from housing 171. Support post assembly 120 includes upright post members 122a and 122b which extend upwardly from angled post members 121a and 121b, respectively. Support post assembly 120 includes horizontal post member 123 which extends between upright post members 122a and 122b. It should be noted that cup 113 is sized and shaped to receive housing 171, as shown in FIG. 9d.

In this embodiment, yieldable fixture assembly 110e includes a mailbox support bar 133 which is carried by horizontal post member 123, and mailbox 104 which is carried by mailbox support bar 133. Further, yieldable fixture assembly 110e includes lamp fixture assembly 140 which is carried by support post assembly 120. In this embodiment, lamp fixture assembly 140 includes lamp post 141 which extends upwardly from an opening 124a of support post assembly 120. It should be noted that opening 124a is covered by cap 124 in FIG. 2a. Lamp fixture assembly 140 includes lamp 142 which is carried by lamp post 141. Lamp fixture assembly 140 includes a personal sign 157 which is carried by lamp post 141. Personal sign 157 can display many different types of personal information, such as a name and/or address. It should be noted that personal sign 157 can be removed from lamp post 141 and replaced with another personal sign. This is useful when it is desired to change the personal information displayed by the sign carried by lamp post 141, such as when moving to another address or when it is desirable to display a different name.

Yieldable fixture assembly 110e includes a reinforcement display piece 125g which is carried by support post assembly 120 in a manner described in more detail above. In this embodiment, yieldable fixture assembly 110e includes brackets 126a and 126b which couple reinforcement display piece 125g to upright post members 122a and 122b, respectively. Reinforcement display piece 125g is embodied as a wrought iron fence. Reinforcement display piece 125g can be removed from support post assembly 120 and replaced with another display piece.

It should be noted that reinforcement display piece 125g is generally configured to counterbalance the weight of lamp fixture assembly 140 so that the center of mass of support post assembly 120 is driven towards reference line 105 (FIG. 9c). The adjustment of the center of mass of support post assembly 120 in response to carrying a display piece is discussed in more detail above with FIGS. 5a-5g. Further, reinforcement display piece 125g is generally configured to counterbalance the weight of mailbox 104 so that the center of mass of support post assembly 120 is driven towards reference line 105 (FIG. 9c). In general, the weights of mailbox 104, reinforcement display piece 125g and lamp fixture assembly 140 are chosen to drive the center of mass of support post assembly 120 towards reference line 105.

In this embodiment, yieldable assembly 170b includes spring 173 with a rigid fastener 172 extending therethrough, as described above. Rigid fastener 172 extends through upwardly facing opening 114 of base post 101, as well as through downwardly facing opening 114 of housing 171. Spring 173 is positioned proximate to downwardly facing opening 114 and receives rigid fastener 172. Washer 174 and nut 175 are coupled to rigid fastener 172 so that spring 173 extends between downwardly facing opening 114 and washer 174. In this way, spring 173 and rigid fastener 172 couple base post assembly 111 and support post assembly 120 together. Spring 173 and rigid fastener 172 allow support post assembly 120 to move between upright and tilted positions in response to a force applied thereto.

FIG. 10 is a partial cut-away view of one embodiment of a yieldable assembly 170d, wherein yieldable assembly 170d couples base post assembly 111 and support post assembly 120 together. More information regarding yieldable assembly 170d can be found in U.S. Pat. No. 2,949,324, the contents of which are incorporated herein by reference. In this embodiment, yieldable assembly 170d includes inner and outer springs 173a and 173b positioned between upper and lower flanges 181 and 180. Yieldable assembly 170d is coupled with base post 101 by a split sleeve clamp 115. Housing 171 is coupled with upper flange 181 and angled post members 121a and 121b. Angled post members 121a and 121b extend from opposed sides of housing 171. Upper flange 181 includes an upwardly facing opening and housing 171 includes a downwardly facing opening, wherein the upwardly and downwardly facing openings face each other. Lower flange 180 includes a downwardly facing opening which faces an upper surface of base post 101.

Yieldable assembly 170d includes an eyebolt 182 which is coupled to one end of inner spring 173a and is fastened with the downwardly facing opening of lower flange 180. Yieldable assembly 170d includes an eyebolt 183 which is coupled to an opposed end of inner spring 173a and is fastened with the openings of housing 171 and upper flange 181. Eyebolt 183 is coupled with housing 171 by using nut 174.

Housing 171 is repeatably moveable between positions towards and away from base post 101 in response to compressing and decompressing, respectively, inner and outer springs 173a and 173b. Further, housing 171 is repeatably moveable between tilted and untilted positions in response to bending inner and outer springs 173a and 173b. Support post assembly 120 has a center of mass that is directed along reference line 105.

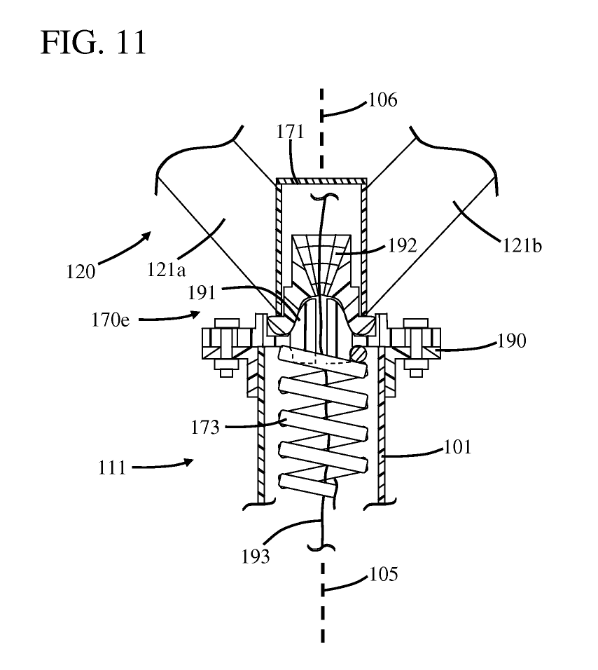

FIG. 11 is a partial cut-away view of one embodiment of a yieldable assembly 170e, wherein yieldable assembly 170e couples base post assembly 111 and support post assembly 120 together. More information regarding yieldable assembly 170e can be found in U.S. Pat. No. 1,679,623, the contents of which are incorporated by reference as though fully set forth herein. In this embodiment, yieldable assembly 170e includes upper and lower flanges 191 and 190 which are coupled together with fasteners. Lower flange 190 is coupled to base post 101 and upper flange 191 is coupled with housing 171. Angled post members 121a and 121b extend from housing 171, as described in more detail above.

In this embodiment, yieldable assembly 170e includes a moveable flange 192 housed by housing 171 and engaged with upper flange 191. A flexible fastener 193, extends through openings of moveable flange 192, upper flange 191 and lower flange 190, wherein the openings of moveable flange 192, upper flange 191 and lower flange 190 are aligned with each other. In this way, flexible fastener 193 extends between housing 171 and base post 101 through the openings of moveable flange 192, upper flange 191 and lower flange 190. Yieldable assembly 170e includes spring 173 which extends through base post 101. Flexible fastener 193 extends through spring 173.

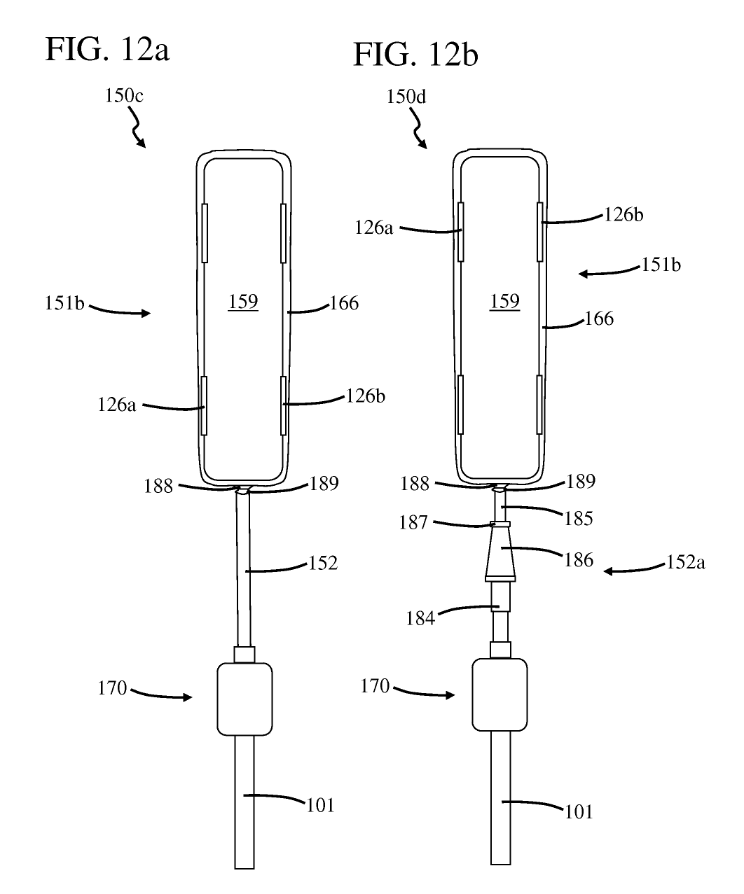

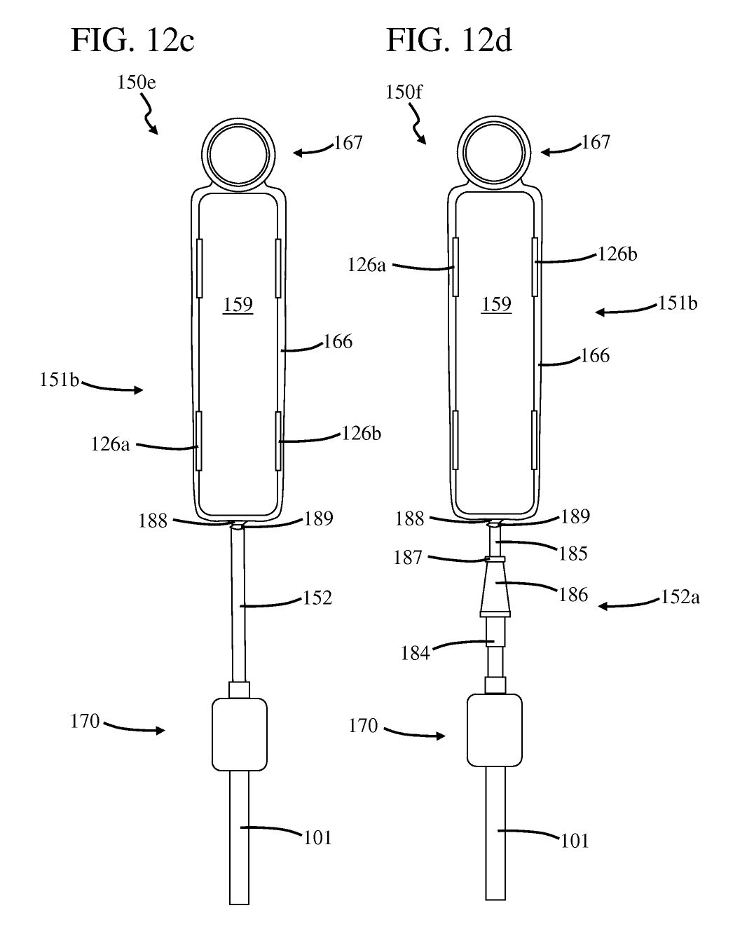

FIG. 12a is a front view of a yieldable sign fixture assembly 150c. More information regarding yieldable sign fixture assembly 150c can be found in U.S. Pat. No. 4,253,415, the contents of which are incorporated by reference as though fully set forth herein. In this embodiment, yieldable sign fixture assembly 150c includes a support post assembly 151b coupled with base post 101 through yieldable assembly 170.

Yieldable assembly 170 allows support post assembly 151b to move between upright and tilted positions, as discussed in more detail above. It should be noted that yieldable assembly 170 of yieldable sign fixture assembly 150c can include any of the yieldable assemblies disclosed herein. In one particular embodiment, yieldable assembly 170 of yieldable sign fixture assembly 150c includes yieldable assembly 170a, which is discussed with FIGS. 8a, 8b and 8c. In another particular embodiment, yieldable assembly 170 of yieldable sign fixture assembly 150c includes yieldable assembly 170b, which is discussed with FIGS. 9a, 9b and 9c.

In this embodiment, support post assembly 151b includes a lower sign post 152 extending upwardly from yieldable assembly 170, and an advertising sign frame 166 connected to lower sign post 152. Advertising sign frame 166 can be connected to lower sign post 152 in many different ways. In this embodiment, advertising sign frame 166 is connected to lower sign post 152 through a hollow cylindrical neck 189 and base clip 188. More information regarding hollow cylindrical neck 189 and base clip 188 can be found in the above-referenced U.S. Pat. No. 4,253,415.

In this embodiment, yieldable sign fixture assembly 150c includes an advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

FIG. 12b is a front view of a yieldable sign fixture assembly 150d. More information regarding yieldable sign fixture assembly 150d can be found in U.S. Pat. No. 4,253,415. In this embodiment, yieldable sign fixture assembly 150c includes support post assembly 151b coupled with base post 101 through yieldable assembly 170.

Yieldable assembly 170 allows support post assembly 151b to move between upright and tilted positions, as discussed in more detail above. It should be noted that yieldable assembly 170 of yieldable sign fixture assembly 150d can include any of the yieldable assemblies disclosed herein. In one particular embodiment, yieldable assembly 170 of yieldable sign fixture assembly 150d includes yieldable assembly 170a, which is discussed with FIGS. 8a, 8b and 8c. In another particular embodiment, yieldable assembly 170 of yieldable sign fixture assembly 150d includes yieldable assembly 170b, which is discussed with FIGS. 9a, 9b and 9c.

In this embodiment, support post assembly 151b includes a lower sign post assembly 152a extending upwardly from yieldable assembly 170, and advertising sign frame 166 connected to lower sign post assembly 152a. Advertising sign frame 166 can be connected to lower sign post assembly 152a in many different ways. In this embodiment, advertising sign frame 166 is connected to lower sign post assembly 152a through hollow cylindrical neck 189 and base clip 188. More information regarding hollow cylindrical neck 189 and base clip 188 can be found in the above-referenced U.S. Pat. No. 4,253,415.

In this embodiment, lower sign post assembly 152a includes a lower tube 184 connected to yieldable assembly 170, and an upper tube 185 connected to lower tube 184 through a base clip 187 and elastic adapter 186. Upper tube 185 is connected to support post assembly 151b through hollow cylindrical neck 189 and base clip 188. More information regarding lower sign post assembly 152a can be found in the above-referenced U.S. Pat. No. 4,253,415.

In some embodiments, elastic adapter 186 includes a molded polyurethane foam piece. Polyurethane material is useful because it has shape memory, wherein the polyurethane returns to its original shape in response to being deformed. Further, polyurethane material is useful because it is lighter in weight than some other elastic materials.

In this embodiment, yieldable sign fixture assembly 150d includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

FIG. 12c is a front view of a yieldable sign fixture assembly 150e. More information regarding yieldable sign fixture assembly 150e can be found in the above-referenced U.S. Pat. No. 4,253,415. In this embodiment, yieldable sign fixture assembly 150e includes a support post assembly 151b coupled with base post 101 through yieldable assembly 170.

Yieldable assembly 170 allows support post assembly 151b to move between upright and tilted positions, as discussed in more detail above. It should be noted that yieldable assembly 170 of yieldable sign fixture assembly 150e can include any of the yieldable assemblies disclosed herein. In one particular embodiment, yieldable assembly 170 of yieldable sign fixture assembly 150e includes yieldable assembly 170a, which is discussed with FIGS. 8a, 8b and 8c. In another particular embodiment, yieldable assembly 170 of yieldable sign fixture assembly 150e includes yieldable assembly 170b, which is discussed with FIGS. 9a, 9b and 9c.

In this embodiment, support post assembly 151b includes lower sign post 152 extending upwardly from yieldable assembly 170, and advertising sign frame 166 connected to lower sign post 152. Advertising sign frame 166 can be connected to lower sign post 152 in many different ways. In this embodiment, advertising sign frame 166 is connected to lower sign post 152 through a hollow cylindrical neck 189 and base clip 188. More information regarding hollow cylindrical neck 189 and base clip 188 can be found in the above-referenced U.S. Pat. No. 4,253,415.

In this embodiment, yieldable sign fixture assembly 150e includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

In this embodiment, yieldable sign fixture assembly 150e includes a light 167. Light 167 is connected to advertising sign frame 166 at a location opposed to lower sign post 152. In this embodiment, light 167 is integrated with advertising sign frame 166 so they are not repeatably separable from each other.

Light 167 can be of many different types, such as an incandescent lamp or a lamp which includes a light emitting diode. Light 167 can be powered in many different ways. In some embodiments, light 167 is connected to a power source (not shown) through a power chord (not shown). In other embodiments, light 167 is connected to a battery or a solar power source. Light 167 is useful because it illuminates the advertisement displayed by advertising sign 159.

FIG. 12d is a front view of a yieldable sign fixture assembly 150f. More information regarding yieldable sign fixture assembly 150f can be found in the above-referenced U.S. Pat. No. 4,253,415. In this embodiment, yieldable sign fixture assembly 150f includes support post assembly 151b coupled with base post 101 through yieldable assembly 170.

Yieldable assembly 170 allows support post assembly 151b to move between upright and tilted positions, as discussed in more detail above. It should be noted that yieldable assembly 170 of yieldable sign fixture assembly 150f can include any of the yieldable assemblies disclosed herein. In one particular embodiment, yieldable assembly 170 of yieldable sign fixture assembly 150f includes yieldable assembly 170a, which is discussed with FIGS. 8a, 8b and 8c. In another particular embodiment, yieldable assembly 170 of yieldable sign fixture assembly 150f includes yieldable assembly 170b, which is discussed with FIGS. 9a, 9b and 9c.

In this embodiment, lower sign post assembly 152a includes lower tube 184 connected to yieldable assembly 170, and upper tube 185 connected to lower tube 184 through base clip 187 and elastic adapter 186. Upper tube 185 is connected to support post assembly 151b through hollow cylindrical neck 189 and base clip 188. More information regarding lower sign post assembly 152a can be found in the above-referenced U.S. Pat. No. 4,253,415.

In some embodiments, elastic adapter 186 includes a molded polyurethane foam piece. Polyurethane material is useful because it has shape memory, wherein the polyurethane returns to its original shape in response to being deformed. Further, polyurethane material is useful because it is lighter in weight than some other elastic materials.

In this embodiment, yieldable sign fixture assembly 150f includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

In this embodiment, yieldable sign fixture assembly 150f includes light 167, which is discussed in more detail above. Light 167 is connected to advertising sign frame 166 at a location opposed to lower sign post assembly 152a. In this embodiment, light 167 is integrated with advertising sign frame 166 so they are not repeatably separable from each other. Light 167 is useful because it illuminates the advertisement displayed by advertising sign 159.

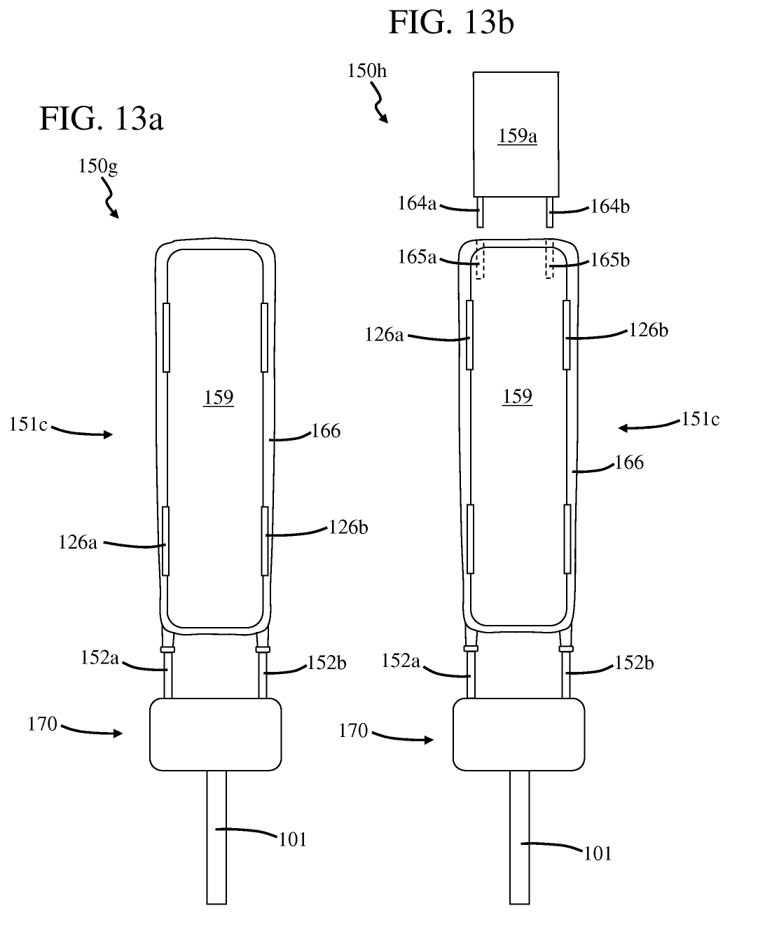

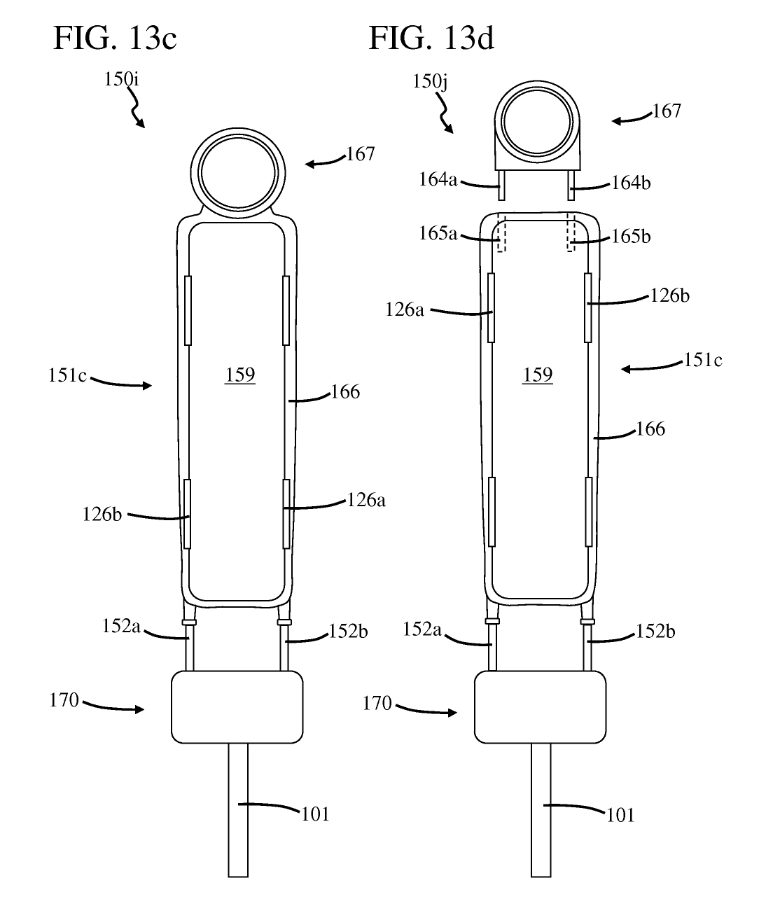

FIG. 13a is a front view of a yieldable sign fixture assembly 150g. More information regarding yieldable sign fixture assembly 150g can be found in the above-referenced U.S. Pat. No. 4,253,415. In this embodiment, yieldable sign fixture assembly 150g includes a support post assembly 151c coupled with base post 101 through yieldable assembly 170.

Yieldable assembly 170 allows support post assembly 151c to move between upright and tilted positions, as discussed in more detail above. It should be noted that yieldable assembly 170 of yieldable sign fixture assembly 150g can include any of the yieldable assemblies disclosed herein. In one particular embodiment, yieldable assembly 170 of yieldable sign fixture assembly 150g includes yieldable assembly 170a, which is discussed with FIGS. 8a, 8b and 8c. In another particular embodiment, yieldable assembly 170 of yieldable sign fixture assembly 150g includes yieldable assembly 170b, which is discussed with FIGS. 9a, 9b and 9c.

In this embodiment, support post assembly 151c includes lower sign posts 152a and 152b extending upwardly from yieldable assembly 170, and advertising sign frame 166 connected to lower sign posts 152a and 152b.

In this embodiment, yieldable sign fixture assembly 150g includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

FIG. 13b is a front view of a yieldable sign fixture assembly 150h. More information regarding yieldable sign fixture assembly 150h can be found in the above-referenced U.S. Pat. No. 4,253,415. In this embodiment, yieldable sign fixture assembly 150h includes support post assembly 151c coupled with base post 101 through yieldable assembly 170.

Yieldable assembly 170 allows support post assembly 151c to move between upright and tilted positions, as discussed in more detail above. It should be noted that yieldable assembly 170 of yieldable sign fixture assembly 150h can include any of the yieldable assemblies disclosed herein. In one particular embodiment, yieldable assembly 170 of yieldable sign fixture assembly 150h includes yieldable assembly 170a, which is discussed with FIGS. 8a, 8b and 8c. In another particular embodiment, yieldable assembly 170 of yieldable sign fixture assembly 150h includes yieldable assembly 170b, which is discussed with FIGS. 9a, 9b and 9c.

In this embodiment, support post assembly 151c includes lower sign posts 152a and 152b extending upwardly from yieldable assembly 170, and advertising sign frame 166 connected to lower sign posts 152a and 152b.

In this embodiment, yieldable sign fixture assembly 150h includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

In this embodiment, yieldable sign fixture assembly 150h includes a sign 159a which is repeatably moveable between engaged and disengaged positions with advertising sign frame 166. Sign 159a can be repeatably moveable between engaged and disengaged positions with advertising sign frame 166 in many different ways. In this embodiment, yieldable sign fixture assembly 150h includes legs 164a and 164b which are connected to sign 159a. Further, advertising sign frame 166 includes sockets 165a and 165b, which extend therethrough at a location opposed to lower sign posts 152a and 152b. Sockets 165a and 165b are positioned to receive legs 164a and 164b, respectively. In this way, sign 159a is repeatably moveable between engaged and disengaged positions with advertising sign frame 166.

FIG. 13c is a front view of a yieldable sign fixture assembly 150i. More information regarding yieldable sign fixture assembly 150i can be found in the above-referenced U.S. Pat. No. 4,253,415. In this embodiment, yieldable sign fixture assembly 150i includes a support post assembly 151c coupled with base post 101 through yieldable assembly 170.

Yieldable assembly 170 allows support post assembly 151c to move between upright and tilted positions, as discussed in more detail above. It should be noted that yieldable assembly 170 of yieldable sign fixture assembly 150i can include any of the yieldable assemblies disclosed herein. In one particular embodiment, yieldable assembly 170 of yieldable sign fixture assembly 150i includes yieldable assembly 170a, which is discussed with FIGS. 8a, 8b and 8c. In another particular embodiment, yieldable assembly 170 of yieldable sign fixture assembly 150i includes yieldable assembly 170b, which is discussed with FIGS. 9a, 9b and 9c.

In this embodiment, support post assembly 151c includes lower sign posts 152a and 152b extending upwardly from yieldable assembly 170, and advertising sign frame 166 connected to lower sign posts 152a and 152b.

In this embodiment, yieldable sign fixture assembly 150i includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

In this embodiment, yieldable sign fixture assembly 150i includes light 167, which is discussed in more detail above. Light 167 is connected to advertising sign frame 166 at a location opposed to lower sign posts 152a and 152b. In this embodiment, light 167 is integrated with advertising sign frame 166 so they are not repeatably separable from each other.

FIG. 13d is a front view of a yieldable sign fixture assembly 150j. More information regarding yieldable sign fixture assembly 150j can be found in the above-referenced U.S. Pat. No. 4,253,415. In this embodiment, yieldable sign fixture assembly 150j includes support post assembly 151c coupled with base post 101 through yieldable assembly 170.

Yieldable assembly 170 allows support post assembly 151c to move between upright and tilted positions, as discussed in more detail above. It should be noted that yieldable assembly 170 of yieldable sign fixture assembly 150j can include any of the yieldable assemblies disclosed herein. In one particular embodiment, yieldable assembly 170 of yieldable sign fixture assembly 150j includes yieldable assembly 170a, which is discussed with FIGS. 8a, 8b and 8c. In another particular embodiment, yieldable assembly 170 of yieldable sign fixture assembly 150j includes yieldable assembly 170b, which is discussed with FIGS. 9a, 9b and 9c.

In this embodiment, support post assembly 151c includes lower sign posts 152a and 152b extending upwardly from yieldable assembly 170, and advertising sign frame 166 connected to lower sign posts 152a and 152b.

In this embodiment, yieldable sign fixture assembly 150h includes advertising sign 159 which displays an advertisement. Advertising sign 159 is attached to advertising sign frame 166 in a repeatably removeable manner. Advertising sign 159 can be attached to advertising sign frame 166 in many different ways so it is repeatably removeable therefrom. In this embodiment, brackets 126a and 126b are used to hold advertising sign 159 to advertising sign frame 166, wherein brackets 126a and 126b are positioned on opposed sides of advertising sign 159. It is useful for advertising sign 159 to be repeatably removeable from advertising sign frame 166 so it can be replaced with another advertising sign, if desired, which displays a different advertisement.

In this embodiment, yieldable sign fixture assembly 150j includes light 167 which is repeatably moveable between engaged and disengaged positions with advertising sign frame 166. Sign 167 can be repeatably moveable between engaged and disengaged positions with advertising sign frame 166 in many different ways. In this embodiment, yieldable sign fixture assembly 150j includes legs 164a and 164b which are connected to light 167. Further, advertising sign frame 166 includes sockets 165a and 165b, which extend therethrough at a location opposed to lower sign posts 152a and 152b. Sockets 165a and 165b are positioned to receive legs 164a and 164b, respectively. In this way, sign 159a is repeatably moveable between engaged and disengaged positions with advertising sign frame 166.

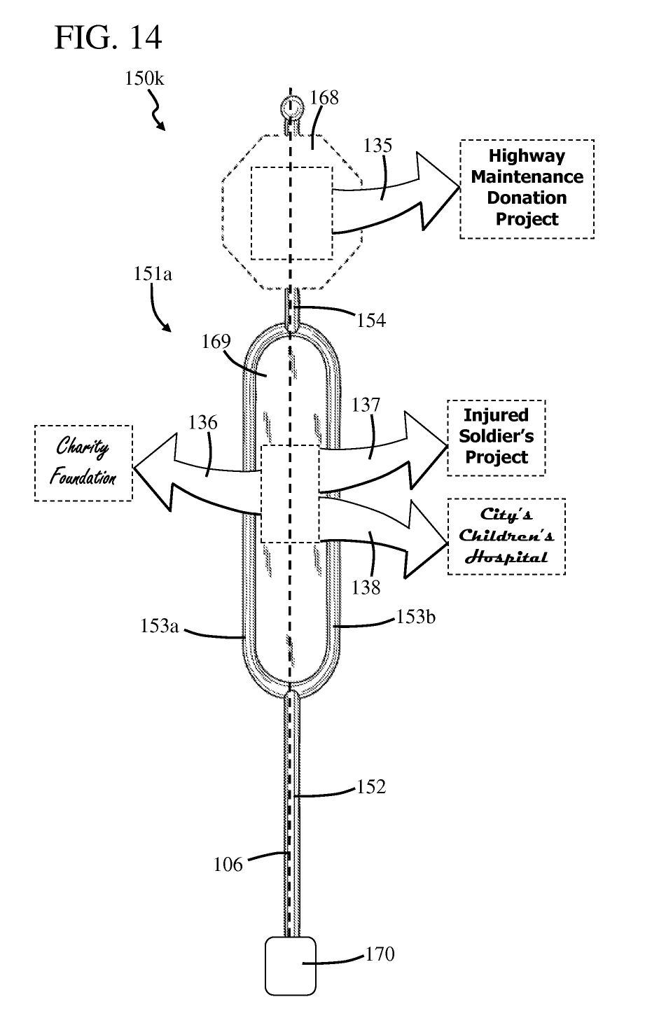

FIG. 14 is a front view of a yieldable sign fixture assembly 150k. More information regarding yieldable sign fixture assembly 150k can be found in the above-referenced U.S. Pat. No. D566,778. In this embodiment, yieldable sign fixture assembly 150k includes support post assembly 151a coupled with a base post assembly (not shown) through yieldable assembly 170. Support post assembly 151a includes lower sign post 152 extending upwardly from yieldable assembly 170, and opposed upright post members 153a and 153b extending upwardly from lower sign post 152. Support post assembly 151a includes upper sign post 154 extending upwardly from opposed upright post members 153a and 153b. A sign 168 is coupled to upper sign post 154, and a sign 169 is positioned so it extends between opposed upright post members 153a and 153b.

Sign 168 can display many different types of information. In one embodiment, sign 168 displays indicia corresponding to a donation project. The donation project can be of many different types, such as a highway maintenance donation project, as indicated by an indication arrow 135.

Sign 169 can display many different types of information. In one embodiment, sign 169 displays indicia corresponding to a charity foundation, as indicated by an indication arrow 136. In another embodiment, sign 169 displays indicia corresponding to a project. The project can be of many different types, such as an injured soldier's project, as indicated by an indication arrow 137. In some embodiments, sign 169 displays indicia corresponding to a medical facility. The medical facility can be of many different types, such as a children's hospital, as indicated by an indication arrow 138.

Upright post members 153a and 153b are chosen to drive the center of mass of support post assembly 151a so it is aligned with reference line 105, as discussed in more detail above. There are many different ways in which upright post members 153a and 153b can be chosen to drive the center of mass of support post assembly 151a so it is aligned with reference line 105. For example, in one embodiment, the weight of upright post member 153a is chosen to be greater than the weight of upright post member 153b so that the center of mass of support post assembly 151a is driven towards upright post member 153a. In another embodiment, the weight of upright post member 153b is chosen to be greater than the weight of upright post member 153a so that the center of mass of support post assembly 151a is driven towards upright post member 153b. In this way, the center of mass of support post assembly 151a can be adjusted by adjusting the weights of upright post members 153a and 153b.

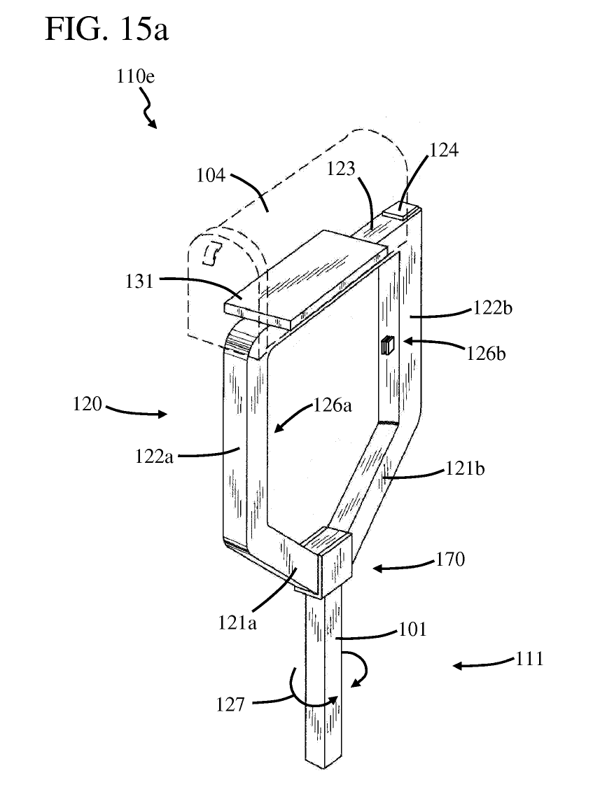

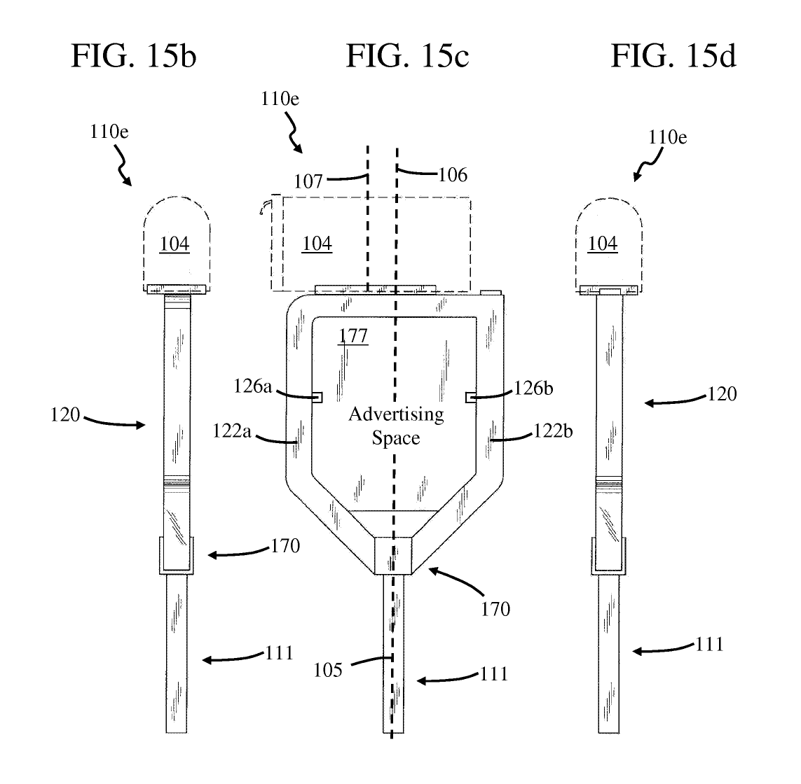

FIG. 15a is a perspective view of one embodiment of a yieldable fixture assembly 110e. FIGS. 15b, 15c and 15d are front, side and back views, respectively, of yieldable fixture assembly 110e. More information regarding yieldable fixture assembly 110e can be found in the above-referenced U.S. Pat. No. D549,924. In this embodiment, yieldable fixture assembly 110e includes base post assembly 111 coupled with support post assembly 120 through a yieldable assembly 170.

It should be noted that yieldable assembly 170 of yieldable mailbox fixture assembly 110a can include any of the yieldable assemblies disclosed herein. In one particular embodiment, yieldable assembly 170 of yieldable fixture assembly 110e includes yieldable assembly 170a, which is discussed with FIGS. 8a, 8b and 8c. In another particular embodiment, yieldable assembly 170 of yieldable fixture assembly 110e includes yieldable assembly 170b, which is discussed with FIGS. 9a, 9b and 9c.

Base post assembly 111 can include many different components, but here it includes base post 101. Base post 101 is typically driven into the ground to provide support for support post assembly 120. Support post assembly 120 carries mailbox 104, which is coupled to mailbox support plate 131.

Yieldable assembly 170 allows support post assembly 120 to repeatably move between upright and tilted positions in response to an applied force. The upright and tilted positions are discussed in more detail above with FIG. 1. Further, more information regarding the upright and tilted positions is provided in the above-referenced U.S. patent application Ser. No. 11/487,674.

Support post assembly 120 generally moves from the upright to the tilted positions in response to the applied force. The force can be applied in many different ways, such as by engaging mailbox 104 or support post assembly 120 with a vehicle. In these situations, it is desirable for support post assembly 120 to move from the upright to the tilted positions in response to being engaged by the vehicle to reduce the amount of damage to yieldable fixture assembly 110e. It should be noted that support post assembly 120 is typically capable of rotating, in a direction 127, about reference line 106 relative to base support structure 111. In this way, support post assembly 120 can also rotate in response to the applied force.

It is generally desirable, however, to have support post assembly 120 remain in the untilted position in the absence of the applied force. Hence, it is desirable to balance support post assembly 120, as well as the components carried by it, such as mailbox 104, so that support post assembly 120 is less likely to undesirably move from the untilted position to the tilted position in the absence of the applied force. Support post assembly 120 can be balanced in many different ways, one of which will be discussed in more detail presently.

In this embodiment, support post assembly 120 includes opposed angled post members 121a and 121b extending upwardly from yieldable assembly 170. Post members 121a and 121b are angled post members because they extend at a non-zero angle relative to base post 101. In this way, post members 121a and 121b do not extend parallel with base post 101. Opposed angled post members 121a and 121b are chosen to restrict the movement of support post assembly 120 from the untilted position to the tilted position. In this way, mailbox 104 is carried by support post assembly 120 so it is balanced over base post assembly 111. Opposed angled post members 121a and 121b can be chosen to restrict the movement of support post assembly 120 from the untilted position to the tilted position in many different ways.

In some embodiments, opposed angled post members 121a and 121b are chosen so that the center of mass of support post assembly 120 is driven to be aligned with reference line 105. In one example, the weights of angled post members 121a and 121b are chosen to drive the center of mass of support post assembly 120 to be aligned with reference line 105 (FIG. 15c). The center of mass of support post assembly 120 is moved towards angled post member 122a in response to increasing the weight of angled post member 122a. Further, the center of mass of support post assembly 120 is moved towards angled post member 122b in response to increasing the weight of angled post member 122b. In this way, the center of mass of support post assembly 120 can be adjusted relative to reference line 105 in response to adjusting the weights of angled post members 121a and 121b. Further, the center of mass of support post assembly 120 can be adjusted relative to base post assembly 111 in response to adjusting the weights of angled post members 121a and 121b.

In this embodiment, support post assembly 120 includes opposed upright post members 122a and 122b extending upwardly from angled post members 121a and 121b, respectively. In some embodiments, post members 122a and 122b extend at an angle relative to base post 101. However, in this embodiment, post members 122a and 122b extend parallel with base post 101. Opposed upright post members 122a and 122b are chosen to restrict the movement of support post assembly 120 from the untilted position to the tilted position. In this way, mailbox 104 is carried by support post assembly 120 so it is balanced over base post assembly 111. Opposed upright post members 122a and 122b can be chosen to restrict the movement of support post assembly 120 from the untilted position to the tilted position in many different ways.

For example, opposed upright post members 122a and 122b are positioned to restrict movement of support post assembly 120 from the untilted position to the tilted position. Opposed upright post members 122a and 122b are chosen so that the center of mass of support post assembly 120 is driven to be aligned with reference line 105. In one example, the weights of upright post members 122a and 122b are chosen to drive the center of mass of support post assembly 120 to be aligned with reference line 105. The center of mass of support post assembly 120 is moved towards upright post member 122a in response to increasing the weight of upright post member 122a. Further, the center of mass of support post assembly 120 is moved towards upright post member 122b in response to increasing the weight of upright post member 122b. In this way, the center of mass of support post assembly 120 can be adjusted relative to reference line 105 in response to adjusting the weights of upright post members 122a and 122b. The center of mass of support post assembly 120 can be adjusted relative to base post assembly 111 in response to adjusting the weights of upright post members 122a and 122b.

Hence, opposed angled post members 121a and 121b, as well as opposed upright members 122a and 122b, are used to balance mailbox 104 over base post assembly 111. Opposed angled post members 121a and 121b, as well as opposed upright members 122a and 122b, are positioned to bias support post assembly 120 to the untilted position. Further, opposed angled post members 121a and 121b, as well as opposed upright members 122a and 122b, are used to balance mailbox 104 over base post assembly 111. Opposed angled post members 121a and 121b, as well as opposed upright members 122a and 122b, are positioned to restrict movement of support post assembly 120 from an untilted position to a tilted position. Further, opposed angled post members 121a and 121b, as well as opposed upright members 122a and 122b, are positioned to bias support post assembly 120 to the untilted position. In this way, support post assembly 120 is balanced so that mailbox 104 is balanced over base post assembly 111.

In this embodiment, support post assembly 120 includes horizontal post member 123 which extends between upright post members 122a and 122b. Horizontal post member 123 is connected to ends of upright post members 122a and 122b opposed to angled post members 121a and 121b. Further, mailbox support plate 131 is carried by horizontal post member 123, wherein mailbox 104 is carried by mailbox support plate 131.

Horizontal post member 123 is positioned to restrict movement of support post assembly 120 from the untilted position to the tilted position. In this way, mailbox 104 is carried by support post assembly 120 so it is balanced over base post assembly 111. Horizontal post member 123 is chosen so that the center of mass of support post assembly 120 is driven to be aligned with reference line 105. In one example, the weight distribution of horizontal post member 123 is chosen to drive the center of mass of support post assembly 120 to be aligned with reference line 105 (FIG. 15c). The center of mass of support post assembly 120 is moved towards upright post member 122a in response to increasing the weight of horizontal post member 123 proximate to upright post member 122a. Further, the center of mass of support post assembly 120 is moved towards upright post member 122b in response to increasing the weight of horizontal post member 123 proximate to upright post member 122b. In this way, the center of mass of support post assembly 120 can be adjusted relative to reference line 105 in response to adjusting the weight distribution of horizontal post member 123. Further, the center of mass of support post assembly 120 can be adjusted relative to base post assembly 111 in response to adjusting the weight distribution of horizontal post member 123.

In some embodiments, support post assembly 120 carries a reinforcement member 125 (FIG. 15c). Reinforcement member 125 can be of many different types, such as a reinforcement display piece, but here it is embodied as an advertising sign plate 177 which includes advertising space for displaying an advertisement. In this embodiment, reinforcement member 125 extends between upright post members 122a and 122b and horizontal post member 123. Reinforcement member 125 provides many different functions. For example, reinforcement member 125 provides reinforcement for support post assembly 120 to make it sturdier. Reinforcement member 125 reinforces support post assembly 120 to make it sturdier because it restricts the ability of upright post members 122a and 122b to move towards and away from each other, such as when a force is applied thereto.

Reinforcement member 125 also provides additional balancing to balance support post assembly 120 over base post assembly 111. For example, the center of mass of support post assembly 120 is moved towards upright post member 122a in response to increasing the weight of reinforcement member 125 proximate to upright post member 122a. Further, the center of mass of support post assembly 120 is moved towards upright post member 122b in response to increasing the weight of reinforcement member 125 proximate to upright post member 122b. In this way, the center of mass of support post assembly 120 can be adjusted relative to reference line 105 in response to adjusting the weight of reinforcement member 125. Further, the center of mass of support post assembly 120 can be adjusted relative to base post assembly 111 in response to adjusting the weight of reinforcement member 125. More information regarding adjusting the weight of reinforcement member 125 is provided in more detail below with the discussion of FIGS. 5a-5g.

Support post assembly 120 can carry reinforcement member 125 in many different ways. In this embodiment, yieldable mailbox fixture assembly 110a includes brackets 126a and 126b which hold reinforcement member 125 to opposed upright members 122a and 122b, respectively. Brackets 126a and 126b allow reinforcement member 125 to be repeatably coupled to and decoupled from support post assembly 120 in a repeatable manner. It should be noted that reinforcement member 125 can be held to support post assembly 120 in many other ways, such as by using bolts or other types of fasteners. More information regarding different ways in which reinforcement member 125 can be coupled to support post assembly 120 is provided in U.S. Pat. Nos. 3,940,900, 4,059,923, 4,634,157, 5,283,975, 6,578,664, 7,152,368, as well as in U.S. Design Pat. Nos. D288,854 and D288,367.

In general, however, reinforcement member 125 is held to support post assembly 120 in a repeatably removeable manner. In this way, reinforcement member 125 can be removed and replaced with another reinforcement member. Hence, the reinforcement members carried by support post assembly 120 are interchangeable. This is useful so that the balance of support post assembly 120 can be adjusted in response to removing one reinforcement member 125 and replacing it with another reinforcement member having a different weight. This is also useful so that the balance of support post assembly 120 can be adjusted in response to removing one reinforcement member 125 and replacing it with another reinforcement member having a different weight distribution. In this way, the center of mass of support post assembly 120 can be adjusted in response to interchanging reinforcement members.

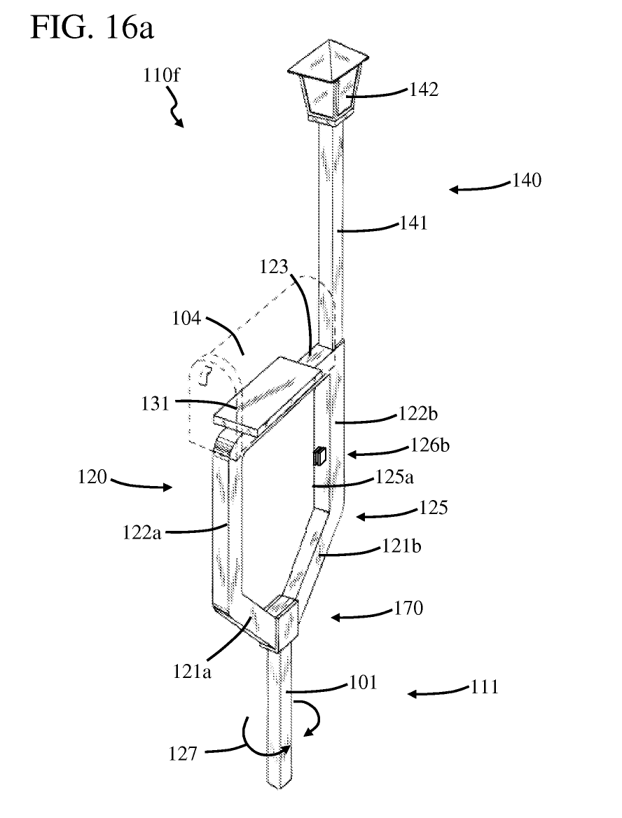

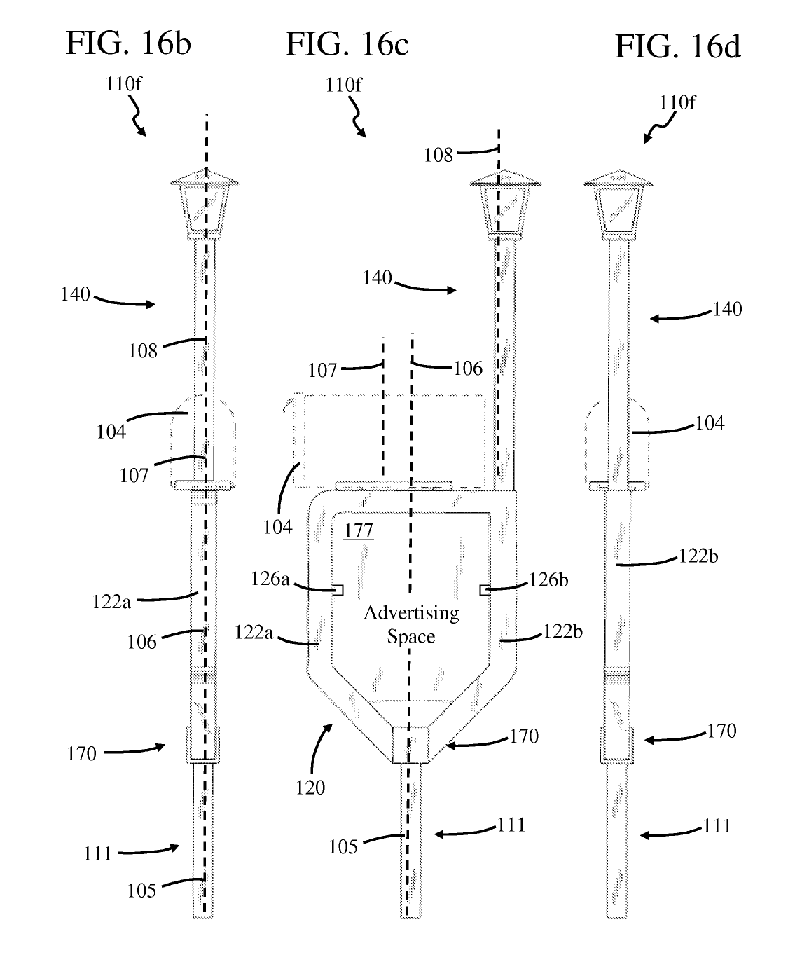

FIG. 16a is a perspective view of one embodiment of a yieldable fixture assembly 110f. FIGS. 16b, 16c and 16d are front, side and back views, respectively, of yieldable fixture assembly 110f. More information regarding yieldable fixture assembly 110f can be found in the above-referenced U.S. Pat. No. D549,923. In this embodiment, yieldable fixture assembly 110f includes yieldable mailbox fixture assembly 110a. Further, yieldable fixture assembly 110f includes a lamp fixture assembly 140 carried by support post assembly 120. Lamp fixture assembly 140 can be carried by support post assembly 120 in many different ways. In this embodiment, lamp fixture assembly 140 extends upwardly from upright post member 122b. In particular, lamp fixture assembly 140 includes a lamp post 141 which extends through an upwardly facing opening 124a (FIG. 10a) of upright post member 122b. Upwardly facing opening 124a of upright post member 122b is covered by a cap 124 in FIG. 15a. Lamp fixture assembly 140 includes a lamp 142 carried by lamp post 141, wherein lamp 142 emits light in response to being powered. Lamp 142 can be powered in many different ways. For example, in some embodiments, light 142 is connected to a power source (not shown) through a power chord (not shown). In other embodiments, light 167 is connected to a battery or a solar power source. Examples of lamps and lamp posts are disclosed in U.S. Pat. No. 6,017,131.

Lamp fixture assembly 140 provides many different functions. For example, lamp fixture assembly 140 provides light, which is emitted by lamp 142. Lamp fixture assembly 140 also provides additional balancing to balance support post assembly 120 over base post assembly 111. The center of mass of support post assembly 120 is moved towards upright post member 122a in response to decreasing the weight of lamp fixture assembly 140. Further, the center of mass of support post assembly 120 is moved towards upright post member 122b in response to increasing the weight of lamp fixture assembly 140. Hence, the center of mass of support post assembly 120 can be adjusted relative to reference line 105 in response to adjusting the weight of lamp fixture assembly 140. In this way, support post assembly 120 is balanced so that mailbox 104 is balanced over base post assembly 111.

It should be noted that the weight distribution of reinforcement member 125 can be adjusted, as described above, to compensate for the weight of lamp fixture assembly 140 so that support post assembly 120 is balanced over base post assembly 111. For example, the center of mass of support post assembly 120 is moved away from lamp fixture assembly 140 in response to increasing the weight of reinforcement member 125 proximate to upright post member 122a. Further, the center of mass of support post assembly 120 is moved towards lamp fixture assembly 140 in response to increasing the weight of reinforcement member 125 proximate to upright post member 122b. Hence, the center of mass of support post assembly 120 can be adjusted relative to reference line 105 and lamp fixture assembly 140 in response to adjusting the weight distribution of reinforcement member 125. As mentioned above, reinforcement member 125 can be of many different types, such as a reinforcement display piece, but here it is embodied as an advertising sign plate 177 which includes advertising space for displaying an advertisement.

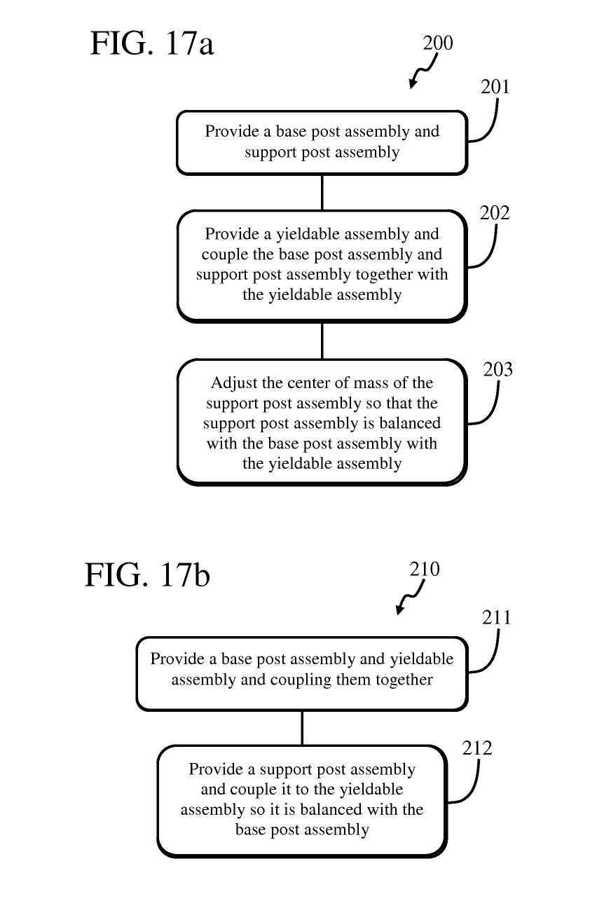

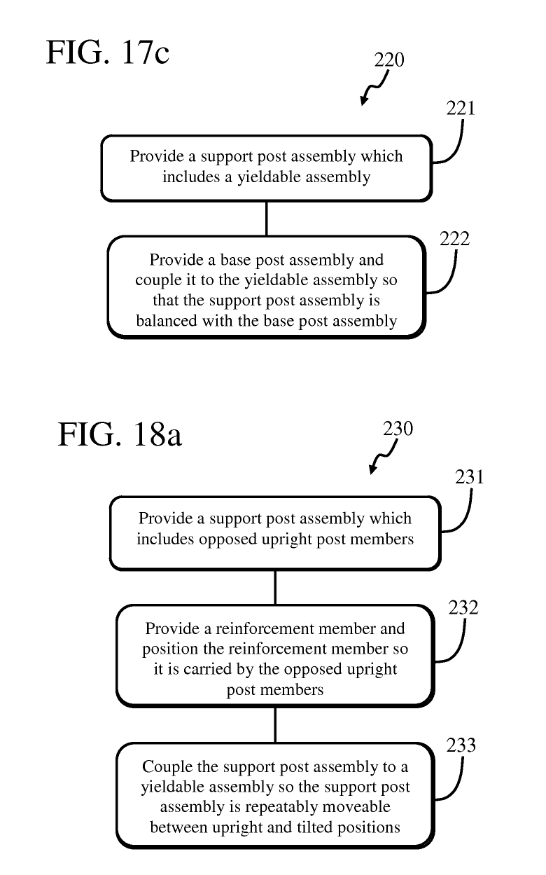

FIG. 17a is a flow diagram of a method 200 of installing a fixture assembly. In this embodiment, method 200 includes a step 201 of providing a base post assembly and support post assembly. Method 200 includes a step 202 of providing a yieldable assembly and coupling the base post assembly and support post assembly together with the yieldable assembly. Method 200 includes a step 203 of adjusting the center of mass of the support post assembly so that the support post assembly is balanced with the base post assembly. The support post assembly is repeatably moveable between upright and tilted positions with the base post assembly.

FIG. 17b is a flow diagram of a method 210 of installing a fixture assembly. In this embodiment, method 210 includes a step 211 of providing a base post assembly and yieldable assembly and coupling them together. Method 210 includes a step 212 of providing a support post assembly and coupling it to the yieldable assembly so it is balanced with the base post assembly. The support post assembly is repeatably moveable between upright and tilted positions with the base post assembly.

FIG. 17c is a flow diagram of a method 220 of installing a fixture assembly. In this embodiment, method 220 includes a step 221 of providing a support post assembly which includes a yieldable assembly. Method 220 includes a step 222 of providing a base post assembly and coupling it to the yieldable assembly so that the support post assembly is balanced with the base post assembly. The support post assembly is repeatably moveable between upright and tilted positions with the base post assembly.

The yieldable assemblies of methods 200, 210 and 220 can be of many different types. In some embodiments, the yieldable assembly includes a spring with a rigid fastener extending therethrough. In some embodiments, the yieldable assembly includes inner and outer springs.

The support post assemblies of methods 200, 210 and 220 can be of many different types. In some embodiments, the yieldable assemblies include opposed upright post members which are positioned to balance the support post assembly with the base post assembly. In some embodiments, the yieldable assemblies include opposed angled post members which are positioned to balance the support post assembly with the base post assembly. In this embodiment, the opposed post members and opposed angled members are positioned to restrict movement of the support post assembly from the untilted position to the tilted position.

In some embodiments, the yieldable assemblies include a horizontal member which extends between the opposed upright members. In some embodiments, a mailbox is positioned so it is carried by the support post assembly, wherein the support post assembly balances the mailbox over the base post assembly.

In some embodiments, the support post assembly includes an upwardly facing opening and the yieldable assembly includes a downwardly facing opening. The upwardly facing opening and downwardly facing opening face each other so that a fastener can extend between them. In some embodiments, the fastener extends through a spring.

It should be noted that methods 200, 210 and 220 can include many other steps. For example, in some embodiments, methods 200, 210 and 220 include a step of adjusting the center of mass of the support post assembly. The center of mass of the support post assembly can be adjusted in many different ways, such as by providing a reinforcement member and coupling it to the support post assembly. In some situations, the center of mass of the support post assembly is adjusted by decoupling a reinforcement member from the support post assembly and replacing it with another one. In some embodiments, the center of mass of the support post assembly is adjusted in response to adjusting the weight of the components (i.e. angled post members, upright post members, horizontal post member) of the support post assembly.

In some embodiments, the center of mass of the support post assembly is adjusted in response to carrying a lamp fixture assembly with the support post assembly. The lamp fixture assembly typically includes a lamp carried by a lamp post. The lamp fixture assembly can be carried by the support post assembly in many different ways. For example, in some embodiments, the support post assembly includes an upwardly facing opening for receiving the lamp post.

In these embodiments, the weight of the lamp fixture assembly can be adjusted by decoupling a lamp from the lamp post and replacing it with another one. A lamp can be repeatably coupled to and decoupled from the lamp post in many different ways. For example, the lamp can be repeatably coupled to and decoupled from the lamp post using a lamp post bracket assembly.

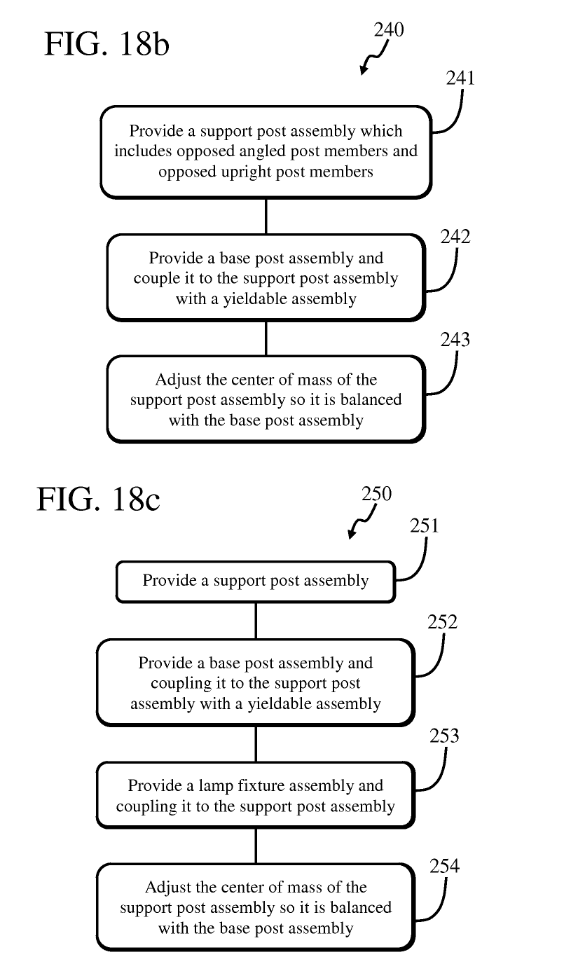

FIG. 18a is a flow diagram of a method 230 of manufacturing a fixture assembly. In this embodiment, method 230 includes a step 231 of providing a support post assembly which includes opposed upright post members. Method 230 includes a step 232 of providing a reinforcement member and positioning the reinforcement member so it is carried by the opposed upright post members. Method 230 includes a step 233 of coupling the support post assembly to a yieldable assembly so the support post assembly is repeatably moveable between upright and tilted positions.

In some embodiments, step 232 of providing the reinforcement member includes a step of cutting through a piece of flat stock material. The flat stock material can be cut in many different ways, such as by using a CNC machine which utilizes laser or plasma cutting.

FIG. 18b is a flow diagram of a method 240 of manufacturing a fixture assembly. In this embodiment, method 240 includes a step 241 of providing a support post assembly which includes opposed angled post members and opposed upright post members. Method 240 includes a step 242 of providing a base post assembly and coupling it to the support post assembly with a yieldable assembly. Method 240 includes a step 243 of adjusting the center of mass of the support post assembly so it is balanced with the base post assembly.

FIG. 18c is a flow diagram of a method 250 of manufacturing a fixture assembly. In this embodiment, method 250 includes a step 251 of providing a support post assembly. Method 250 includes a step 252 of providing a base post assembly and coupling it to the support post assembly with a yieldable assembly. Method 250 includes a step 253 of providing a lamp fixture assembly and coupling it to the support post assembly. Method 250 includes a step 254 of adjusting the center of mass of the support post assembly so it is balanced with the base post assembly.

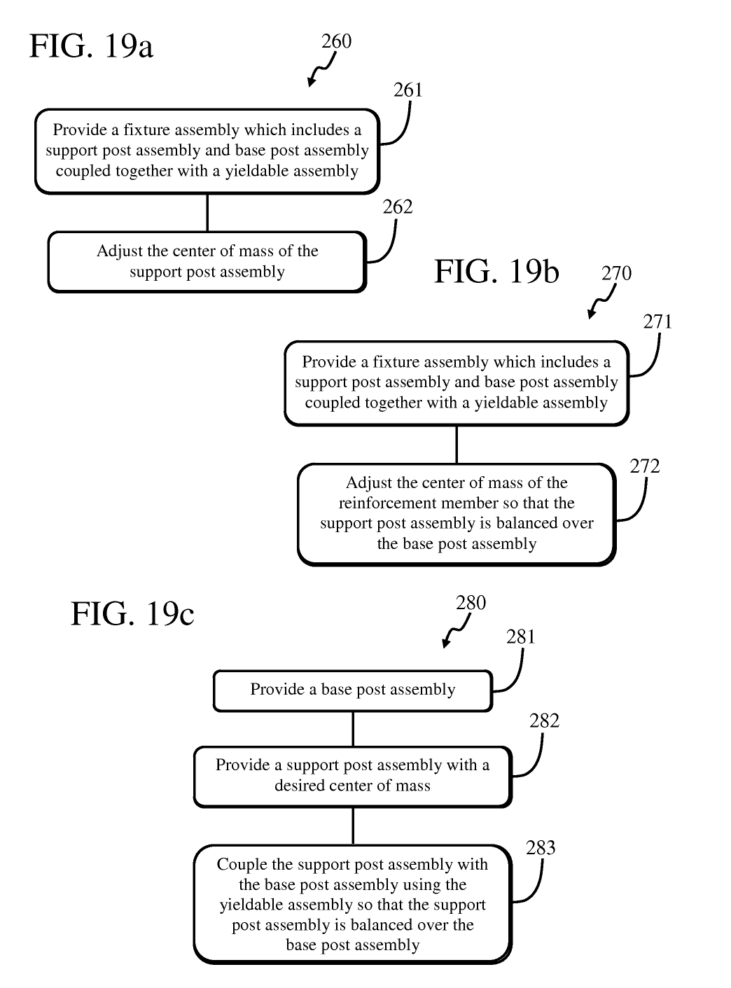

FIG. 19a is a flow diagram of a method 260 of balancing a fixture assembly. In this embodiment, method 260 includes a step 261 of providing a fixture assembly which includes a support post assembly and base post assembly coupled together with a yieldable assembly. Method 260 includes a step 262 of adjusting the center of mass of the support post assembly so that the support post assembly is balanced over the base post assembly.

FIG. 19b is a flow diagram of a method 270 of balancing a fixture assembly. In this embodiment, method 270 includes a step 271 of providing a fixture assembly which includes a support post assembly and base post assembly coupled together with a yieldable assembly. In this embodiment, the support post assembly includes a reinforcement member. Method 270 includes a step 272 of adjusting the center of mass of the reinforcement member so that the support post assembly is balanced over the base post assembly.

FIG. 19c is a flow diagram of a method 280 of balancing a fixture assembly. In this embodiment, method 280 includes a step 281 of providing a base post assembly and a step 282 of providing a support post assembly with a desired center of mass. Method 280 includes a step 283 of coupling the support post assembly with the base post assembly using the yieldable assembly so that the support post assembly is balanced over the base post assembly.

The center of mass of the support post assembly can be chosen in many different ways. For example, in one embodiment, the support post assembly includes opposed upright post members and the center of mass of the support post assembly is chosen by choosing the weight of the opposed upright post members. In one embodiment, the support post assembly includes opposed angled post members and the center of mass of the support post assembly is chosen by choosing the weight of the opposed angled post members. In one embodiment, the support post assembly includes a reinforcement member and the center of mass of the support post assembly is chosen by choosing the weight distribution of the reinforcement member.

In some embodiments, the fixture assembly includes a lamp fixture assembly carried by the support post assembly. In these embodiments, the center of mass of the support post assembly is chosen to counterbalance the weight of the lamp fixture assembly. In some embodiments, the lamp fixture assembly includes a lamp carried by a lamp post. If desired, the lamp can be coupled to and decoupled from the lamp post in a repeatable manner. Hence, a lamp can be decoupled from the lamp post and replaced with another one. In this way, the weight of the lamp fixture assembly is adjustable.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A post structure, comprising:
a base post having an upwardly facing opening;
a post component which includes a housing with a bottom wall having an opening facing the opening of the base post;
a rigid fastener which extends through the base and bottom wall openings, and a first washer engaged with the fastener; and
a spring positioned between the bottom wall and first washer.

2. The post structure of claim 1, wherein the rigid fastener includes a bolt head, and the base and bottom wall openings are positioned between the bolt head and spring.

3. The post structure of claim 1, further including a second washer positioned between the spring and bottom wall of the housing.

4. The post structure of claim 3, wherein the rigid fastener includes a bolt head, and the second washer is positioned between the bolt head and spring.

5. The post structure of claim 1, wherein the rigid fastener extends through opposed openings of the spring.

6. The post structure of claim 1, wherein the rigid fastener includes threaded and non-threaded portions which extend through opposed openings of the spring.

7. A post structure, comprising:
a bolt having a bolt head and bolt shaft;
a spring having first and second opposed openings through which the bolt shaft extends;
first and second washers positioned proximate to the first and second opposed openings, respectively, of the spring;
a nut which biases the first washer to the spring; and
a support post assembly having a housing, wherein the housing includes a housing end wall which biases the second washer to the spring.

8. The post structure of claim 7, further including a base post having an upwardly facing end wall, and an upwardly facing opening extending through the upwardly facing end wall.

9. The post structure of claim 8, wherein the bolt shaft extends through the upwardly facing opening.

10. The post structure of claim 7, wherein the housing end wall includes a downwardly facing opening through which the bolt shaft extends.

11. The post structure of claim 7, wherein the rigid fastener includes threaded and non-threaded portions which extend through the first and second opposed openings, respectively, of the spring.

12. The post structure of claim 7, wherein the spring is compressed between the first and second washers.

13. A post structure, comprising:
a base post which includes an upwardly facing end wall having an upwardly facing opening extending therethrough;
a housing which includes a housing end wall having a downwardly facing opening extending therethrough;
a rigid fastener having a shaft extending upwardly through the upwardly and downwardly facing openings; and
a spring, wherein the shaft extends through first and second opposed openings of the spring.

14. The post structure of claim 13, wherein the shaft includes threaded and non-threaded portions which extend through the first and second opposed openings, respectively, of the spring.

15. The post structure of claim 14, wherein the non-threaded portion of the shaft extends through the upwardly and downwardly facing openings.

16. The post structure of claim 13, wherein the spring is compressed between first and second opposed washers.

17. The post structure of claim 13, wherein the spring is compressed in response to tilting the housing relative to the base post.

18. The post structure of claim 13, further including a washer and nut, wherein the nut holds the washer to the spring.

19. The post structure of claim 18, wherein the nut and washer are positioned away from the upwardly and downwardly facing openings.

20. The post structure of claim 13, wherein the rigid fastener includes a head, wherein the upwardly and downwardly facing openings extend between the head and spring.
